(19) United States
(12) Patent Application Publication
(10) Pub. No.: US 2026/0340469 A1
(43) Pub. Date: Oct. 29, 2026

(54) PATTERN-LOCK TOPOLOGICAL BOUNDARY DEVICES METHODS AND APPARATUS FOR LOSSLESS EDGE CHANNELS AND GOLDEN-RATIO TILED SURFACE-CODE QUBITS USING RECOGNITION-PHYSICS PATTERN-CHARGE INVARIANT

(71) Applicant: Jonathan Washburn, Austin, TX (US)

(72) Inventor: Jonathan Washburn, Austin, TX (US)

(21) Appl. No.: 19/652,207

(22) Filed: Apr. 20, 2026

Related U.S. Application Data
(60) Provisional application No. 63/794,540, filed on Apr. 25, 2025.

(51) Int. Cl. G06N 10/40; G06N 10/70

(52) U.S. Cl. CPC G06N 10/40; G06N 10/70

(57) ABSTRACT

A pattern-lock device includes a first region having a first integer pattern-charge value J1, a second region having a second integer pattern-charge value J2 different from J1, and an interface between the regions. When DeltaJ=J2−J1 is non-zero, the interface supports one or more localized boundary modes. In preferred embodiments, the device includes a spacer selected to support interface localization, and each mode contributes a conductance quantum e\hat{ }2/h. The interface may be patterned as a routing network or along edges of an aperiodic tiling so that vertices define stabilizer sites of a qubit fabric. Disclosed embodiments further include photonic interfaces, multi-mode bus structures, superconducting hybrids, stacked architectures, controller-coupled systems, fabrication methods, validation methods, and non-transitory computer-readable media storing fabrication and runtime-control packages for implementing and operating the device.

### CROSS-REFERENCE TO RELATED APPLICATIONS

This application claims the benefit of U.S. Provisional Patent Application No. 63/794,540, filed on Apr. 25, 2025, the disclosure of which is incorporated herein by reference to the extent permitted and to the extent not inconsistent with the present disclosure.

### BACKGROUND OF THE INVENTION

The present invention relates generally to condensed-matter electronics, photonics, and quantum-information hardware, and more particularly to devices, systems, and methods that form protected boundary modes at engineered interfaces between regions having different pattern-charge values, including implementations for low-loss or lossless transport, patterned qubit fabrics, topological routing networks, photonic waveguides, controller-supported quantum architectures, and related design, fabrication, validation, and control technologies.

Conventional approaches for obtaining protected edge transport have typically relied on physical mechanisms that impose significant practical constraints at the device, manufacturing, and system levels. Quantum Hall systems can provide dissipation-resistant edge transport, but such systems generally depend on strong external magnetic fields and cryogenic operating conditions. Those requirements complicate packaging, increase system overhead, constrain deployment environments, and make large-scale integration with conventional semiconductor control hardware difficult. In mixed-signal or quantum-computing environments, reliance on strong magnetic fields can also create design conflicts with neighboring structures, controller electronics, shielding strategies, and routing density targets.

Other approaches based on topological insulators, Chern insulators, or related topological materials can reduce or eliminate dependence on externally applied magnetic fields in some cases, but these approaches often remain sensitive to bulk leakage, material defects, magnetic-order tuning, stoichiometric drift, disorder, interface roughness, and narrow process windows. In practical device stacks, even when a desired boundary state is predicted, bulk conduction or parasitic conduction paths can degrade isolation, reduce transport fidelity, blur quantized response, and complicate interpretation of measured performance. Such issues matter not only for scientific characterization, but also for manufacturability, repeatability, wafer-scale screening, and reproducible behavior under process variation.

Approaches aimed at topological quantum computing using exotic quasiparticle platforms, including certain Majorana-oriented implementations, can present additional challenges. Such approaches may depend on specialized material systems, narrow operating envelopes, complex heterostructures, difficult interface engineering, or fabrication sequences that are yield-sensitive and not easily transferable to mainstream semiconductor manufacturing lines. In many practical settings, the resulting integration burden extends beyond the active device itself and affects controller attachment, thermal staging, signal delivery, verification flow, and quality-control methodology. A platform that depends on fragile or difficult-to-reproduce physical conditions can therefore be technically interesting while still being unattractive for scalable deployment.

Conventional qubit-fabric architectures likewise present limitations. Periodic lattices, while conceptually simple, can impose repeating geometric constraints that may permit translationally correlated defect patterns, repeated routing bottlenecks, repeating coupler conflicts, or area-efficiency ceilings associated with regular grid geometry. In fault-tolerant architectures, lattice geometry is not merely a visual design choice; it affects stabilizer placement, routing congestion, control-line topology, patch shaping, code distance per area, and the spatial distribution of correlated error opportunities. A regular lattice may therefore be easier to describe abstractly while still being suboptimal for certain scaling, packing, or error-suppression objectives.

Conventional interconnect structures also remain a significant source of technical limitation, particularly in dense cryogenic systems and hybrid classical/quantum platforms. Metallic interconnects dissipate power, generate heat, contribute voltage drop, and can require repeaters, buffering, or thermal-management overhead as routing complexity increases. In systems where many qubit sites, measurement points, controller paths, or optical/electrical interfaces must coexist within a limited die area or package envelope, interconnect loss and routing overhead can become an architectural bottleneck rather than a secondary implementation detail. The problem is amplified where both quantum-state-sensitive regions and classical drive or readout regions must coexist on the same chip, same package, or same thermal stack.

Manufacturing constraints further narrow the practical value of many proposed edge-state or qubit technologies. A device concept that requires extreme processing temperatures, uncommon precursor chemistries, non-standard substrate handling, or process steps incompatible with CMOS back-end-of-line constraints may be difficult to scale even if the underlying physics is promising. Likewise, a platform that cannot be integrated with controller circuitry, packaging, wafer-scale metrology, or automated design flows may face substantial deployment barriers. From a prosecution standpoint, the technical problem is therefore not merely to produce an interesting interface phenomenon, but to provide a device architecture and implementation path that can be fabricated, patterned, contacted, controlled, validated, and scaled in a reproducible engineering environment.

There remains a need for technical solutions that can create protected boundary transport without requiring the same dependence on strong external fields, exotic tuning, or difficult-to-manufacture material stacks that characterize many prior approaches. There also remains a need for architectures in which the same underlying interface principle can be extended beyond a single transport channel and used in patterned networks, routing fabrics, qubit layouts, photonic structures, and controller-coupled systems. Still further, there remains a need for a platform that can support aperiodic qubit-fabric geometries, provide structured routing through bends, crossings, branches, and meshes, and maintain compatibility with practical fabrication flows and validation procedures.

The inventors recognized that prior approaches generally fail to provide, in a unified and scalable manner, all of the following at once: protected boundary transport arising from an engineered interface property rather than solely from an external field; patterned interface networks that can be laid out as aperiodic qubit fabrics; routing structures suitable for low-loss or lossless on-chip communication; compatibility with manufacturable thin-film, lithographic, etch, passivation, and contact processes; and extension to associated controller, software, photonic, stacked, superconducting, flexible, and classical-signaling embodiments. The absence of such a unified platform matters because examiner-facing enablement and industrial implementation both depend on more than a single physical effect. They depend on whether the architecture can be specified concretely, fabricated repeatably, controlled deterministically, validated objectively, and adapted across multiple deployment modes without requiring a later continuation-in-part merely to add missing implementation substance.

Accordingly, what is needed is a self-contained device and method framework in which first and second material or functional regions having different pattern-charge values are arranged to create one or more protected boundary modes at an interface, and in which that interface can be implemented not only as a single channel but also as a patterned network supporting transport, routing, sensing, photonic guidance, fault-tolerant qubit fabrics, controller-linked operation, and scalable manufacturing pathways. The present disclosure addresses these and other technical problems.

### SUMMARY OF THE INVENTION

The present disclosure provides pattern-lock topological boundary devices and related methods, systems, interconnects, controller architectures, software-supported design flows, and computer-readable media in which one or more protected boundary modes are formed at an engineered interface between regions having different pattern-charge values. In broad terms, a first region having a first pattern-charge value J1 and a second region having a second pattern-charge value J2 are arranged so that an interface between the regions exhibits a pattern-charge discontinuity DeltaJ=J2−J1. When DeltaJ is non-zero, the interface supports one or more localized boundary modes. In preferred embodiments, the number of supported modes scales with |DeltaJ|, thereby allowing the same architectural principle to support single-mode transport, multi-mode transport, and higher-bandwidth interface networks.

In certain embodiments, the device is implemented as a layered heterostructure including a substrate, a first material layer, a spacer layer, and a second material layer. The first and second material layers are selected, configured, or engineered so that they correspond to different pattern-charge sectors, and the spacer layer is selected to support formation of a boundary transition region that localizes a protected boundary mode at or proximate the interface. In preferred embodiments, the boundary region is associated with a recognition scale X that crosses an optimal recognition scale X_opt, and a preferred normalized spacer relation is given by X_opt=phi/pi, d_norm=(X_opt)\hat{ }(½)=(phi/pi)\hat{ }(½), and d=d_norm*l_ref, where l_ref is a dimensional reference length. These phi-derived relations are preferred implementations and design rules, while broader embodiments include any spacer selection, interface geometry, or dimensional arrangement that supports the disclosed boundary-mode behavior.

In certain embodiments, each protected boundary mode contributes a conductance quantum chi_edge=e\hat{ }2/h, and the total conductance for a multi-mode interface can be expressed as chi_total=|DeltaJ|*e\hat{ }2/h. In this manner, the disclosed architecture provides an objective physical mechanism linking a non-zero pattern-charge discontinuity to measurable transport consequences. The technical effect is not merely a desired result, but arises from the disclosed arrangement of adjacent regions, interface localization, transition-region formation, and material/spacer selection. The present disclosure therefore provides a concrete device architecture that can be fabricated, contacted, measured, and validated using semiconductor-compatible process flows and transport-characterization techniques.

In certain embodiments, the interface is not limited to a straight line or a single boundary segment. Instead, the interface may be patterned into curves, loops, bends, T-junctions, crossings, branches, trees, meshes, or tiled boundary networks. This permits the boundary modes to function as on-chip transport paths, readout buses, control buses, interferometric paths, sensing paths, qubit-to-qubit links, or mixed communication structures. The resulting technical advantage is architecture-level reuse of the same boundary-mode principle across routing, control, and computational layouts, reducing the need to treat transport, qubit placement, and interconnect design as unrelated engineering problems.

In certain embodiments, the interface network is patterned according to an aperiodic tiling, including Penrose tilings formed from kite and dart tiles. In such embodiments, interface paths follow tile edges and tile vertices become stabilizer sites within a surface-code or surface-code-like qubit fabric. Different subsets of vertices can be assigned to data-qubit functions and ancilla-qubit functions, and logical operator paths can extend across selected regions of the aperiodic fabric. The technical effect of the aperiodic arrangement is that translationally repeating geometries can be reduced or avoided, thereby suppressing certain translationally correlated error structures and increasing effective code distance per unit area in certain embodiments. The disclosure therefore provides not merely an abstract qubit layout, but a physically grounded interface architecture that links material structure, transport pathways, tiling geometry, stabilizer placement, routing topology, and error-management behavior.

In certain embodiments, stabilizer operations are implemented at degree-3, degree-5, or other vertex types within a patterned fabric. X-type and Z-type stabilizer measurements can be carried out using local couplers, resonators, measurement lines, multiplexing structures, and controller-directed timing sequences. The disclosure therefore supports device-level and controller-level implementations in which stabilizer-site operation is tied to concrete hardware elements rather than described only as abstract code theory. In preferred system embodiments, cryo-CMOS controller circuitry addresses qubit sites, distributes bias or timing signals, multiplexes readout paths, digitizes measurement outputs, stores syndrome information, and coordinates runtime operation of the patterned interface network.

In certain embodiments, the controller architecture includes one or more controller ASICs, interposers, line bundles, multiplexed address buses, analog front ends, digital processors, firmware stores, memories, and external interfaces. The controller may be co-integrated on the same wafer, coupled through the same package, placed on an interposer, or positioned at a different thermal stage than the qubit or transport die. Thermal zoning may therefore be used so that one portion of the system operates at one temperature range while another portion operates at a different temperature range. This provides a practical path to mixed-temperature deployment without requiring the active boundary-mode structures and all support circuitry to share identical operating conditions.

In certain embodiments, the present disclosure also provides fabrication methods in which a substrate is prepared, a first material layer is formed, a spacer layer is deposited, a second material layer is formed, and one or more patterning, annealing, passivation, metallization, singulation, packaging, or controller-attachment operations are performed. Example process flows include molecular beam epitaxy, atomic layer deposition, lithographic patterning, trench etching, conformal passivation, and ohmic contact formation. Preferred embodiments maintain process temperatures at or below about 450 C, thereby supporting compatibility with CMOS-oriented manufacturing environments. The technical effect is a disclosed pathway from architecture to manufacturable device, reducing the gap between conceptual topological behavior and practical wafer-level implementation.

In certain embodiments, the invention extends to non-transitory computer-readable media and software-supported design tools. A computer-readable medium may store mask-layout data, stack-definition data, process recipes, SPICE models or equivalent device models, stabilizer-tile compiler logic, logical-qubit mapping logic, routing-synthesis logic, controller firmware images, fabrication output packages, and runtime control packages. In this way, the disclosure supports both the physical device and the machine-actionable artifacts used to design, fabricate, validate, and operate the device. This distinction is technically important because design files, process definitions, runtime control packages, and compiler outputs are not merely descriptive records; they can drive fabrication tools, controller subsystems, verification environments, and deployment workflows.

In certain embodiments, the disclosed pattern-lock principle is also implemented in photonic structures. A first photonic crystal region having a first pattern-charge value and a second photonic crystal region having a second pattern-charge value are arranged to define a photonic interface that supports a guided optical mode. Such a mode may propagate around bends, including sharp bends, with reduced backscattering relative to conventional waveguides. In preferred embodiments, the photonic structure is configured for operation around a telecom wavelength, including approximately 1.55 um. In further embodiments, the photonic structure is coupled to a qubit fabric or related device through a transducer or coupling region, thereby supporting quantum-network-node or optical interconnect applications.

In certain embodiments, higher-|DeltaJ| interfaces support multiple boundary modes and therefore can be used as parallel lanes in a higher-bandwidth on-chip bus. In certain embodiments, alternative quasicrystalline tilings, including Ammann-Beenker tilings, are used in place of or in addition to Penrose tilings. In certain embodiments, multiple patterned interface layers are vertically stacked and interconnected using vertical vias or equivalent structures to form a three-dimensional network or topological-code volume. In certain embodiments, a superconducting layer is coupled to a pattern-lock interface to form a superconducting hybrid or proximitized region. In certain embodiments, the device is formed on a flexible substrate and is packaged for bend-tolerant or wearable operation. In certain embodiments, the boundary-mode transport architecture is used in classical interconnect systems, including repeater-free spans, branch nodes, and multi-lane buses. These embodiments provide a layered disclosure structure in which the same core interface principle is shown to support narrower and broader implementations without requiring a later application merely to add variant support.

In certain embodiments, the disclosure provides a fault-tolerant quantum computer including a patterned qubit fabric and associated controller electronics, a topological quantum memory storing logical information in a code-space defined by the patterned fabric, a quantum network node coupling a photonic interface to a qubit architecture, a sensing device using a boundary channel as an interferometric or phase-sensitive path, and mixed quantum/classical systems in which the same chip or package supports more than one transport modality. The present disclosure therefore does not stop at a single materials stack or laboratory demonstration, but instead provides support for apparatus claims, method claims, controller claims, software/media claims, and system claims that all remain anchored to the same disclosed technical architecture.

In certain embodiments, formal verification artifacts, including mathematically formalized relations for interface discontinuity, conductance quantization, aperiodic tiling properties, and spacer-selection rules, are used as supportive design-validation tools. Such formal verification is not required to practice every embodiment, but it provides an additional mechanism for confirming consistency of design rules, compiler outputs, parameter selections, or validation workflows. Likewise, experimental and validation pathways disclosed herein, including boundary-sharpness measurement, transport plateau measurement, non-local voltage measurement, qubit-fabric testing, and photonic bend testing, provide objective routes for confirming operation of representative embodiments.

Accordingly, the present disclosure provides a technical solution to multiple technical problems through a unified architecture in which a non-zero pattern-charge discontinuity at an engineered interface produces one or more protected boundary modes that can be used for transport, routing, sensing, qubit-fabric formation, photonic guidance, controller-coupled operation, and scalable semiconductor-compatible implementation. The invention thereby addresses shortcomings of prior systems that depend on strong external fields, narrow tuning windows, yield-sensitive exotic structures, periodic lattice constraints, or lossy routing architectures, while providing a prosecution-ready disclosure that supports broad and fallback claim coverage across apparatus, method, system, and computer-readable-medium forms.

### BRIEF DESCRIPTION OF THE DRAWINGS

The accompanying drawings illustrate selected embodiments of the disclosed pattern-lock topological boundary devices, methods, systems, and related implementations and are provided to facilitate explanation of the disclosure rather than to limit the scope of the invention. For drawing clarity, each figure uses its own reference numeral series. Components in different figures may correspond functionally even when assigned different reference numerals.

FIG. 1 is a schematic view of an overall pattern-lock device architecture 100 including a substrate 102, a first material layer 104, a spacer layer 106, a second material layer 108, an interface 110, an edge channel 112, a first contact 114, a second contact 116, a gate structure 118, a dielectric layer 120, a controller interconnect 122, a package 124, a contact pad 126, a passivation layer 128, an isolation trench 130, a support substrate region 132, a bonding region 134, and an external connection port 136.

FIG. 2 is a schematic cross-sectional and conceptual boundary view of a boundary device region 200 including a first pattern-charge region 202, a second pattern-charge region 204, a boundary transition region 206, a first pattern-charge value J1 at 208, a second pattern-charge value J2 at 210, a pattern-charge jump DeltaJ at 212, a recognition scale curve 214, an optimal-scale reference line 216, a localized boundary mode 218, a forward propagating mode 220, a reverse propagating mode 222, a measurement axis x at 224, an interface centerline 226, a first-side region thickness 228, a second-side region thickness 230, a transition width 232, a mode confinement region 234, a field-intensity curve 236, and a boundary-normal direction 238.

FIG. 3 is a schematic stack-design and spacer-selection view of a stack embodiment 300 including a first candidate material layer 302, a second candidate material layer 304, a candidate spacer layer 306, a first layer thickness 308, a spacer thickness d at 310, a second layer thickness 312, a reference length l_ref at 314, a normalized spacer factor d_norm at 316, a deposition direction 318, an anneal step 320, a passivation cap 322, a trench opening 324, a growth surface 326, a spacer deposition surface 328, an upper interface plane 330, a lower interface plane 332, a target thickness range 334, and a thickness tolerance range 336.

FIG. 4 is a process-flow diagram of a fabrication method 400 including substrate preparation 402, first layer growth 404, spacer deposition 406, second layer growth 408, anneal 410, lithography mask formation or use 412, trench etch 414, passivation 416, contact metallization 418, wafer singulation 420, package assembly 422, process control by a process controller 424, a metrology checkpoint 426, an alignment mark 428, recipe storage 430, a process record 432, an inspection station 434, a finished device output 436, and a rework branch 438.

FIG. 5 is a schematic plan view of a qubit fabric 500 including a Penrose tile region 502 having kite tiles 504 and dart tiles 506, tile edge interfaces 508, vertex stabilizer sites 510, a data-qubit site 512, an ancilla-qubit site 514, a syndrome path 516, a lattice pitch 518, a code patch boundary 520, a logical operator path 522, a defect feature 524, a boundary vertex 526, an interior vertex 528, an interface junction 530, a patch interior region 532, a patch edge segment 534, a readout access path 536, a control access path 538, a reserved inactive site 540, a logical boundary segment 542, a defect perimeter 544, a tile group 546, and a code-distance path 548.

FIG. 6 is a schematic stabilizer-site architecture 600 including an edge channel input 602, an edge channel output 604, a vertex junction 606, an X-stabilizer measurement path 608, a Z-stabilizer measurement path 610, a coupler 612, a readout resonator 614, a local controller line 616, a multiplexing element 618, an amplifier 620, an analog-to-digital interface 622, a timing controller 624, a bias input 626, a return path 628, a node output line 630, a calibration input 632, a filter element 634, a switching element 636, a local storage element 638, and a diagnostic line 640.

FIG. 7 is a schematic routing network embodiment 700 including a first interface segment 702, a second interface segment 704, a bend 706, a T-junction 708, a crossing 710, a branch output 712, an H-tree trunk 714, an H-tree branch 716, a mesh segment 718, a source node 720, a destination node 722, a readout bus 724, a control bus 726, a branch input 728, a path-selection node 730, a reserved path 732, an active path 734, a standby path 736, a loop path 738, a calibration path 740, an alternate path 742, a monitored junction 744, a path monitor 746, and a timing-distribution path 748.

FIG. 8 is a schematic system-integration view of a quantum computing system 800 including a qubit die 802, a cryo-CMOS controller ASIC 804, an interposer 806, a control line bundle 808, a readout line bundle 810, a multiplexed address bus 812, a bias source 814, an analog front end 816, a digital processor 818, a memory 820, a firmware store 822, an external I/O 824, a cryostat stage 826, a higher-temperature stage 828, a package substrate 830, a clock source 832, a power-management block 834, a data link 836, a thermal sensor 838, a calibration control block 840, a verification block 842, a host interface 844, an update port 846, and a diagnostics bus 848.

FIG. 9 is a schematic photonic device 900 including a first photonic crystal region 902, a second photonic crystal region 904, a photonic interface 906, a guided optical mode 908, an optical input 910, an optical output 912, a sharp bend 914, a bend radius 916, a coupling region 918, a transducer 920, a wavelength lambda at 922, a cladding 924, an optical confinement region 926, an optical propagation path 928, an input coupler 930, an output coupler 932, a defect cavity 934, a mode-conversion section 936, and a photonic support substrate 938.

FIG. 10 is a schematic multi-mode interface device 1000 including a first region 1002, a second region 1004, a boundary 1006, a first mode 1008, a second mode 1010, a third mode 1012, a total conductance chi_total at 1014, a mode separator 1016, a bus segment 1018, lane 1 at 1020, lane 2 at 1022, lane 3 at 1024, a lane combiner 1026, a lane splitter 1028, a lane monitor 1030, a lane control input 1032, a multi-mode boundary region 1034, and a multi-mode output node 1036.

FIG. 11 is a schematic alternative quasicrystalline fabric 1100 including an Ammann-Beenker tile region 1102 having square tiles 1104 and rhombus tiles 1106, tile edge interfaces 1108, degree-four vertices 1110, degree-eight vertices 1112, a data-qubit site 1114, an ancilla-qubit site 1116, a stabilizer path 1118, a patch boundary 1120, a logical path 1122, an error-correction region 1124, a boundary vertex 1126, an interior vertex 1128, an interface junction 1130, a routing segment 1132, a reserved defect region 1134, a patch interior region 1136, and a logical span path 1138.

FIG. 12 is a schematic stacked device 1200 including a first patterned layer 1202, a second patterned layer 1204, a third patterned layer 1206, an interlayer dielectric 1208, a vertical via 1210, a first vertical connection 1212, a second vertical connection 1214, a stacked controller 1216, an encoded volume region 1218, a package substrate 1220, a thermal link 1222, an enclosure 1224, an upper routing layer 1226, a lower routing layer 1228, a layer-alignment region 1230, a vertical signal path 1232, a vertical readout path 1234, a vertical control path 1236, a stack support frame 1238, a heat-spreading element 1240, and an external package connection 1242.

### DETAILED DESCRIPTION OF THE INVENTION

The present disclosure describes pattern-lock topological boundary devices, methods, systems, and related implementations in which one or more protected boundary modes are established at an engineered interface between adjacent regions having different pattern-charge values. The disclosed architecture is useful across electrical, quantum-information, photonic, routing, sensing, and mixed-domain embodiments because the same underlying interface principle can be implemented in a single channel, a patterned network, an aperiodic qubit fabric, a photonic waveguide, or a controller-coupled system. Unless expressly stated otherwise, the disclosed embodiments are illustrative rather than limiting, and features described in connection with one embodiment may be combined with features of another embodiment to the extent not technically incompatible.

As used in this disclosure, the term pattern-charge refers to an integer index assigned to a material region, functional region, photonic region, or other physically realizable region of a device. Pattern-charge is used to distinguish adjacent regions that belong to different pattern sectors for purposes of defining an interface and predicting whether one or more localized boundary modes can exist at that interface. The integer pattern-charge J assigned to a region is distinct from the scalar cost relation J_cost(X), and those concepts should not be conflated. In preferred explanatory embodiments, J_cost(X)=0.5*(X+1/X)−1 is used as a design-support relation, while the interfacial architecture itself is described in terms of adjacent regions having different integer pattern-charge values J1 and J2.

As further used in this disclosure, DeltaJ denotes the pattern-charge discontinuity between adjacent regions and is expressed as DeltaJ=J2−J1. The operative condition for boundary-mode formation in broad embodiments is DeltaJ !=0. In preferred embodiments, the number of localized boundary modes can scale with the magnitude of the discontinuity according to N_modes=|DeltaJ|, although the practical observability, separation, or independent addressability of those modes may depend on the selected material system, interface geometry, controller configuration, and operating conditions. Where transport behavior is discussed, each mode may contribute chi_edge=e\hat{ }2/h, and multi-mode embodiments may exhibit chi_total=|DeltaJ|*e\hat{ }2/h in preferred cases.

As also used in this disclosure, a pattern-lock interface is an interface between adjacent regions having different pattern-charge values, whether the interface is planar, curved, vertical, lateral, looped, branched, crossed, tiled, stacked, or otherwise realized in a fabricated structure. A boundary mode, edge channel, or protected mode refers to a localized mode associated with that interface. The term protected does not require that every embodiment be immune to every non-ideal physical effect. Rather, the term indicates that the mode is tied to the maintained difference in pattern-charge across the interface and is resistant to removal by smooth perturbations that preserve the respective pattern-charge values on opposite sides of the boundary.

The terms ballistic, lossless, and low-loss are used in their ordinary engineering sense to describe transport behavior with substantially reduced scattering, backscattering, dissipation, or effective resistance relative to ordinary conductive or waveguiding paths under comparable conditions. These terms are not intended to require a mathematically perfect zero-dissipation result in every fabricated sample or every measurement setup. Likewise, when code distance, temperature robustness, magnetic-field robustness, qubit count, wavelength, lane count, or other performance values are mentioned, those values are exemplary unless later claimed expressly. Narrower values, broader values, intermediate values, overlapping values, and functionally similar values are all contemplated to the extent supported by the present disclosure.

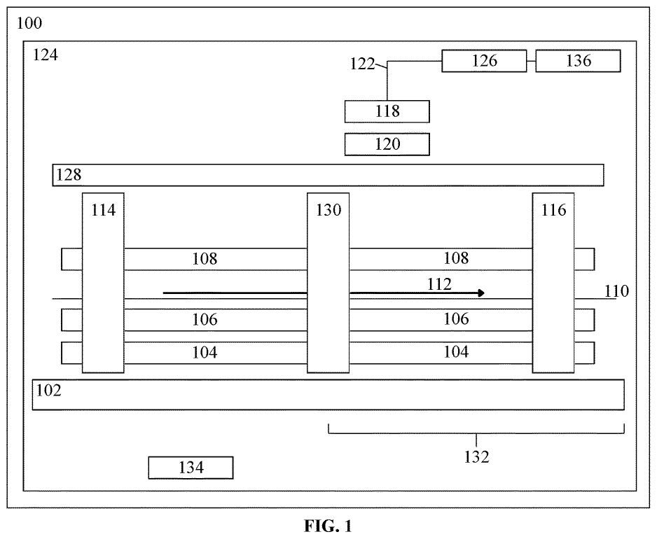

For drawing clarity, each figure uses its own reference numeral series. Components in different figures may correspond functionally even when assigned different reference numerals. The present Detailed Description is drafted so that all reference numerals associated with FIGS. 1-12 are expressly supported in the specification, and the disclosure is not intended to require identical geometry, scale, or orientation to the schematic depictions in the drawings.

Turning to the general device architecture, FIG. 1 illustrates an overall pattern-lock device architecture 100 that includes a substrate 102, a first material layer 104, a spacer layer 106, a second material layer 108, an interface 110, an edge channel 112, a first contact 114, a second contact 116, a gate structure 118, a dielectric layer 120, a controller interconnect 122, a package 124, a contact pad 126, a passivation layer 128, an isolation trench 130, a support substrate region 132, a bonding region 134, and an external connection port 136. In the illustrated embodiment, the substrate 102 provides the mechanical and process foundation for the overlying active stack. The substrate 102 may be semiconducting, insulating, crystalline, amorphous, layered, composite, flexible, or otherwise selected according to process compatibility, thermal budget, lattice compatibility, optical needs, packaging constraints, or target operating environment.

Within the FIG. 1 architecture 100, the first material layer 104 establishes a first region associated with a first pattern-charge value, and the second material layer 108 establishes a second region associated with a second pattern-charge value different from the first. The spacer layer 106 is disposed between those layers in the illustrated heterostructure embodiment and contributes to formation of a controlled boundary transition environment at or near the interface 110. The interface 110 may be physically realized as a laterally extending boundary, a sidewall-defined boundary, a trench-defined boundary, a vertical transition region, or another structurally defined region at which the first material layer 104 and second material layer 108 cooperate to support the edge channel 112. The edge channel 112 is shown schematically to represent one or more localized boundary modes that arise from the engineered discontinuity between the adjacent pattern sectors.

The first contact 114 and second contact 116 may be provided for injection, extraction, probing, sensing, calibration, transport measurement, or operational coupling to the active boundary structure. Depending on the embodiment, the first contact 114 and second contact 116 may be ohmic contacts, tunneling contacts, capacitive couplers, optical couplers, hybrid couplers, or other structures suitable for accessing the interface-supported mode. The contact pad 126 may provide an enlarged attachment or probing surface coupled to one or both of the contacts 114 and 116. The gate structure 118 may be used to tune local electrostatic conditions, occupancy conditions, switching conditions, confinement characteristics, or readout behavior, while the dielectric layer 120 may isolate the gate structure 118, stabilize local fields, support integration, or provide gate-dielectric functionality. In some embodiments the gate structure 118 is omitted, and the device operates through material and structural design alone.

The passivation layer 128 may overlie selected exposed portions of the device to reduce contamination, oxidation, charge drift, or moisture intrusion. The isolation trench 130 may electrically, structurally, or thermally isolate a selected active region from an adjacent region and may also define part of a patterned boundary layout. The support substrate region 132 may represent a thicker, mechanically supporting, or partially inactive portion of the substrate stack beneath or adjacent to the active portion of the device. The bonding region 134 may represent a mechanically or electrically joined region through which the device is attached to another layer, support member, interposer, carrier, or package element. The external connection port 136 may provide a package-level, board-level, probe-level, or module-level access point for electrical or other signal coupling.

The controller interconnect 122 provides a path between the active stack and one or more external or co-integrated controller resources. The controller interconnect 122 may include traces, bumps, interposer routing, wire bonds, through-substrate or through-package connections, optical couplers, or other communication structures depending on the system architecture. The package 124 may provide mechanical support, environmental protection, signal routing, optical access, thermal management, shielding, stage coupling, or integration with a larger module. Thus, even at the level of FIG. 1, the architecture 100 is not a bare material stack only, but a system-ready device structure that can be fabricated, contacted, packaged, and operated.

The illustrated stack of FIG. 1 is one representative implementation and does not limit the broader invention to a single vertically ordered three-layer structure. In other embodiments, the first material layer 104 and second material layer 108 may be formed laterally, in partially overlapping regions, in repeated module cells, in stacked arrays, or in patterned segments distributed across a die. Likewise, the spacer layer 106 may be continuous, patterned, segmented, locally varied in thickness, replaced with a gap structure, or omitted in certain direct-interface embodiments. What is important is that the architecture intentionally establishes adjacent regions with different pattern-charge values and a realizable interface 110 that supports one or more localized boundary modes.

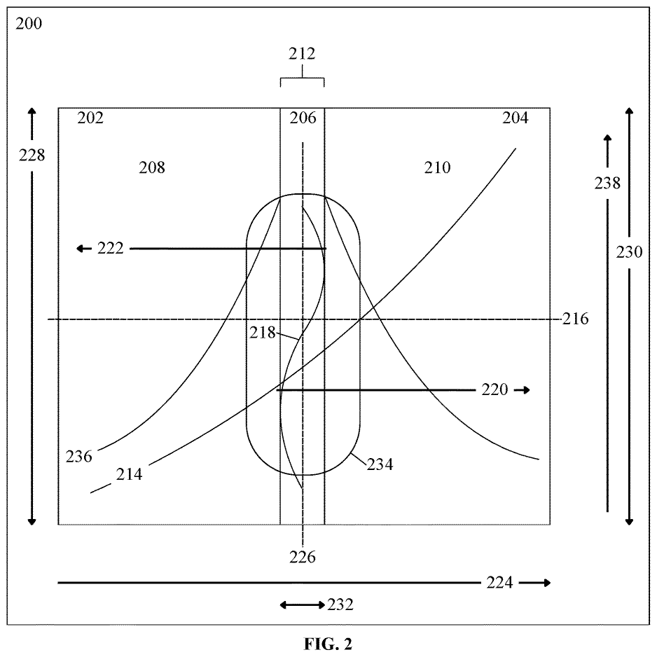

FIG. 2 illustrates a boundary device region 200 showing a first pattern-charge region 202, a second pattern-charge region 204, a boundary transition region 206, a first pattern-charge value J1 at 208, a second pattern-charge value J2 at 210, a pattern-charge jump DeltaJ at 212, a recognition scale curve 214, an optimal-scale reference line 216, a localized boundary mode 218, a forward propagating mode 220, a reverse propagating mode 222, a measurement axis x at 224, an interface centerline 226, a first-side region thickness 228, a second-side region thickness 230, a transition width 232, a mode confinement region 234, a field-intensity curve 236, and a boundary-normal direction 238. This figure is useful in showing that the interface is not treated merely as a mathematical discontinuity of zero thickness. Instead, the boundary transition region 206 is a physically meaningful region across which adjacent pattern sectors are brought into relationship and across which localization of the boundary mode occurs.

In the FIG. 2 embodiment, the first pattern-charge region 202 is associated with the first pattern-charge value J1 indicated at 208, and the second pattern-charge region 204 is associated with the second pattern-charge value J2 indicated at 210. The pattern-charge jump DeltaJ at 212 represents the inter-regional discontinuity and is the operative quantity for determining whether one or more boundary modes are supported. In broad embodiments, any non-zero DeltaJ may support at least one localized mode. In preferred embodiments, higher magnitudes of DeltaJ support multiple modes, allowing the same interfacial principle to scale from single-channel transport to multi-lane transport and broader interface-network architectures.

The recognition scale curve 214 and the optimal-scale reference line 216 provide a preferred design framework for explaining how the boundary transition region 206 can be selected and tuned. In preferred embodiments, the recognition scale curve 214 crosses the optimal-scale reference line 216 within the boundary transition region 206 or in close proximity to the interface centerline 226. In preferred embodiments, X_opt=phi/pi, d_norm=(X_opt)\hat{ }(½)=(phi/pi)\hat{ }(½), and d=d_norm*l_ref, where l_ref is a reference length used to dimensionalize the normalized relation. These phi-derived expressions are preferred and advantageous because they provide a reproducible design rule for spacer selection and boundary configuration. At the same time, the invention is not limited to only those embodiments that literally calculate phi-based values, because broader implementations may instead select dimensions, profiles, and interface conditions functionally so as to support the same boundary-mode behavior.

The localized boundary mode 218 is shown at or near the portion of the boundary transition region 206 associated with the crossing of the recognition scale curve 214 and the optimal-scale reference line 216. The forward propagating mode 220 and reverse propagating mode 222 represent directional transport components or directional aspects of boundary-localized transport. These directional depictions are schematic and need not imply that all embodiments have identical dispersion, symmetry, or measurement signatures. They do, however, provide concrete support for later descriptions of transport, routing, and interconnect behavior. The measurement axis x at 224 provides a frame for cross-sectional metrology, field profiling, spectroscopy, microscopy, or simulation-based validation of the interfacial structure. The interface centerline 226 may be used as a reference for describing the location of the transition width 232, the mode confinement region 234, and the field-intensity curve 236 relative to the boundary.

The first-side region thickness 228 and the second-side region thickness 230 provide representative dimensional measures for the adjacent regions flanking the interface. The transition width 232 represents the finite width across which the change between the first pattern-charge region 202 and the second pattern-charge region 204 is physically realized. The mode confinement region 234 identifies the portion of the structure in which the localized boundary mode 218 is substantially confined, while the field-intensity curve 236 may represent a schematic distribution of field magnitude or mode amplitude across the cross section. The boundary-normal direction 238 provides a directional reference orthogonal or approximately orthogonal to the interface centerline 226 and may be used in measurement, simulation, or fabrication descriptions.

The protection of the localized boundary mode 218 can be understood operationally as follows. If fabrication variation, smooth local disorder, thermal drift, or comparable perturbations modify the structure without eliminating the maintained pattern-charge distinction between the first pattern-charge region 202 and the second pattern-charge region 204, the localized mode remains tied to the interface rather than disappearing merely because the exact microscopic realization has changed. This does not mean that all practical metrics remain constant under all perturbations. Conductance, coherence, scattering length, loss, coupling strength, or bandwidth may change in non-ideal structures. The key point is that the architectural origin of the mode lies in the interfacial discontinuity itself, not in a fragile isolated resonance unrelated to the pattern-charge boundary.

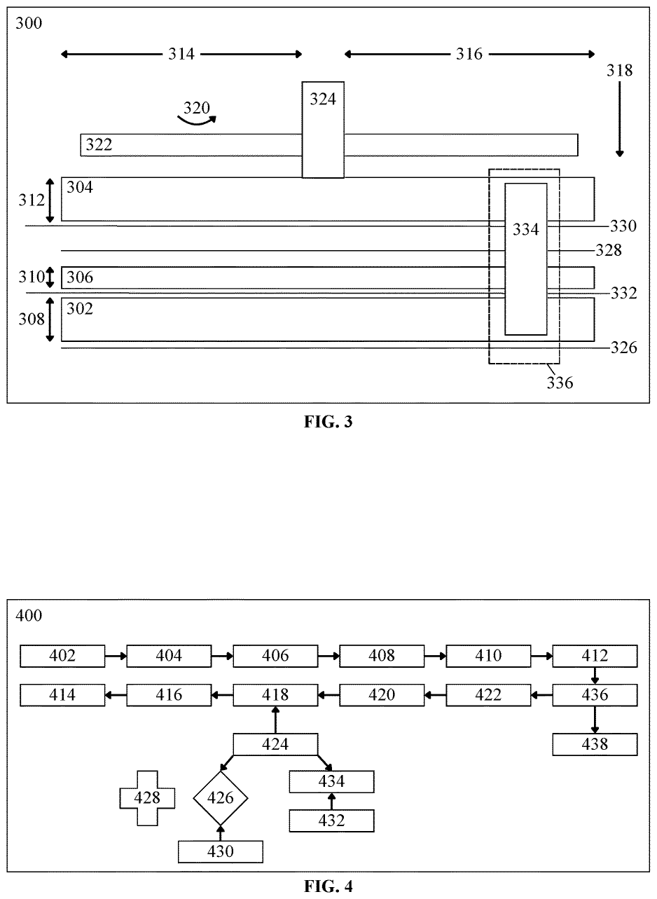

FIG. 3 illustrates a stack embodiment 300 including a first candidate material layer 302, a second candidate material layer 304, a candidate spacer layer 306, a first layer thickness 308, a spacer thickness d at 310, a second layer thickness 312, a reference length l_ref at 314, a normalized spacer factor d_norm at 316, a deposition direction 318, an anneal step 320, a passivation cap 322, a trench opening 324, a growth surface 326, a spacer deposition surface 328, an upper interface plane 330, a lower interface plane 332, a target thickness range 334, and a thickness tolerance range 336. This figure supports the practical reality that the disclosed invention is not restricted to one exact material stack, but instead provides a structured family of stack designs governed by interfacial objectives.

The first candidate material layer 302 may include or represent materials or structures suitable for implementing a first or lower pattern-charge region, including SiC, h-BN, Al2O3, and other insulating or semiconducting materials. The second candidate material layer 304 may include or represent materials or structures suitable for implementing a second or different pattern-charge region, including Bi2Se3, MoS2, graphene-hBN heterostructures, and other engineered materials or composite structures. The candidate spacer layer 306 may include or represent Al2O3, HfO2, van der Waals gaps, layered dielectric structures, amorphous oxides, or other interfacial materials selected to establish the desired transition behavior. Pattern-charge assignment may arise through material choice, layer order, doping, strain engineering, moire engineering, stacking sequence, structural symmetry, compositional design, or combinations thereof.

The first layer thickness 308, spacer thickness d at 310, and second layer thickness 312 are each selectable according to process constraints and interface objectives. The reference length l_ref at 314 and the normalized spacer factor d_norm at 316 provide a preferred relationship between normalized design criteria and physical dimensions. In representative embodiments, the first layer thickness 308 may be about 10 nm to about 50 nm, the second layer thickness 312 may be about 5 nm to about 20 nm, and the spacer thickness 310 may be selected using the preferred normalized relation associated with d_norm at 316 and l_ref at 314. Those values are exemplary rather than limiting. The important point is that the stack embodiment 300 provides dimensional knobs that can be selected deliberately rather than by trial-and-error alone, and that the selected thicknesses cooperate to support the desired interface behavior.

The deposition direction 318 indicates that the layers can be established through sequential growth, deposition, transfer, lamination, or similar build-up processes. The anneal step 320 represents a thermal or other post-formation treatment used to stabilize the stack, improve interface quality, assist pattern-lock formation, or reduce process-induced variation. The passivation cap 322 may protect upper surfaces from oxidation, contamination, or environmental drift, while the trench opening 324 may define where interface paths are exposed, patterned, or spatially resolved for later routing, stabilizer, or bus functions. The growth surface 326 may represent the surface on which a layer is initially formed, and the spacer deposition surface 328 may represent the surface onto which the candidate spacer layer 306 is deposited or otherwise established. The upper interface plane 330 and lower interface plane 332 provide geometric references for the opposing sides of the interface-defining stack relationship.

The target thickness range 334 may represent a preferred or acceptable design range for one or more selected layer thicknesses used in constructing the stack embodiment 300. The thickness tolerance range 336 may represent a fabrication tolerance band within which the realized dimensions remain acceptable for the intended boundary-mode behavior. In some embodiments, the target thickness range 334 and thickness tolerance range 336 are generated, stored, or checked by design-automation or process-control software. In other embodiments, they are derived empirically or by a combination of theory and measurement. Thus FIG. 3 bridges material selection, dimensional selection, and process acceptance criteria.

FIG. 4 illustrates a fabrication method 400 including substrate preparation 402, first layer growth 404, spacer deposition 406, second layer growth 408, anneal 410, lithography mask 412, trench etch 414, passivation 416, contact metallization 418, wafer singulation 420, package assembly 422, and a process controller 424. The figure further includes a metrology checkpoint 426, an alignment mark 428, recipe storage 430, a process record 432, an inspection station 434, a finished device output 436, and a rework branch 438. This process flow is a representative example of how the architecture can be built in a semiconductor-compatible environment and is useful for enablement because it shows a concrete sequence from substrate to packaged device.

During substrate preparation 402, the chosen substrate may be cleaned, planarized, degassed, baked, chemically conditioned, aligned, mounted, or otherwise readied for subsequent processing. The alignment mark 428 may be established before, during, or after substrate preparation 402 to support later patterning, overlay accuracy, and positional control. First layer growth 404 may be carried out using molecular beam epitaxy or another thin-film process capable of establishing the first material layer with the intended structural characteristics. Spacer deposition 406 may be carried out using atomic layer deposition or another controlled process that supports thin, uniform interfacial formation. Second layer growth 408 may then establish the second material layer without materially degrading the already formed lower portions of the stack. In preferred process examples, temperatures may be selected so that the overall thermal budget remains at or below about 450 C.

The anneal 410 may be a rapid thermal operation, flash anneal, inert-gas anneal, forming-gas anneal, or another post-growth treatment used to stabilize the stack and sharpen or condition the effective interface. The lithography mask 412 defines the spatial pattern for interface segments, trenches, tile edges, routing structures, contact regions, or other device features. Trench etch 414 then removes selected portions of upper material to expose or define the intended interface geometry. Passivation 416 protects the patterned structure. Contact metallization 418 establishes electrical access using one or more contact systems selected according to the active material chemistry. Wafer singulation 420 and package assembly 422 then prepare the device for standalone use or integration into a larger module. The finished device output 436 represents a resulting device or device lot that has progressed through the intended fabrication path.

The process controller 424 may be a computer-controlled fabrication supervisor that issues recipes, monitors chamber conditions, logs process parameters, checks metrology outputs, and determines whether the evolving device remains within an acceptance window. The recipe storage 430 may contain one or more process recipes, parameter sets, or approved build sequences. The process record 432 may store execution history, measured conditions, timestamps, parameter values, pass-fail results, or other provenance data associated with the fabrication run. The metrology checkpoint 426 may represent a point in the process at which dimensional, structural, optical, electrical, or compositional measurements are performed, and the inspection station 434 may represent a location, tool, or process stage at which the device is visually, microscopically, electrically, or otherwise inspected. The rework branch 438 may represent a branch in the process flow used when one or more results do not satisfy acceptance criteria but the device or lot remains salvageable through additional processing, correction, or requalification.

With respect to representative values, first layer growth 404 may be performed at about 350 C to about 400 C with a thickness on the order of about 10 nm to about 50 nm, spacer deposition 406 may be performed at about 200 C to about 300 C with sub-nanometer or nanometer-scale control, second layer growth 408 may be performed at about 250 C to about 350 C with a thickness on the order of about 5 nm to about 20 nm, and anneal 410 may include a brief peak around 450 C. Trench etch 414 may define interface paths with widths on the order of about 50 nm to about 100 nm in representative embodiments. These values are examples and serve to demonstrate manufacturability, not to limit the invention to one numerical window. In that sense, the fabrication method 400 is not limited to manual execution, but can be recipe-driven, calibration-driven, adaptive, model-assisted, or software-generated.

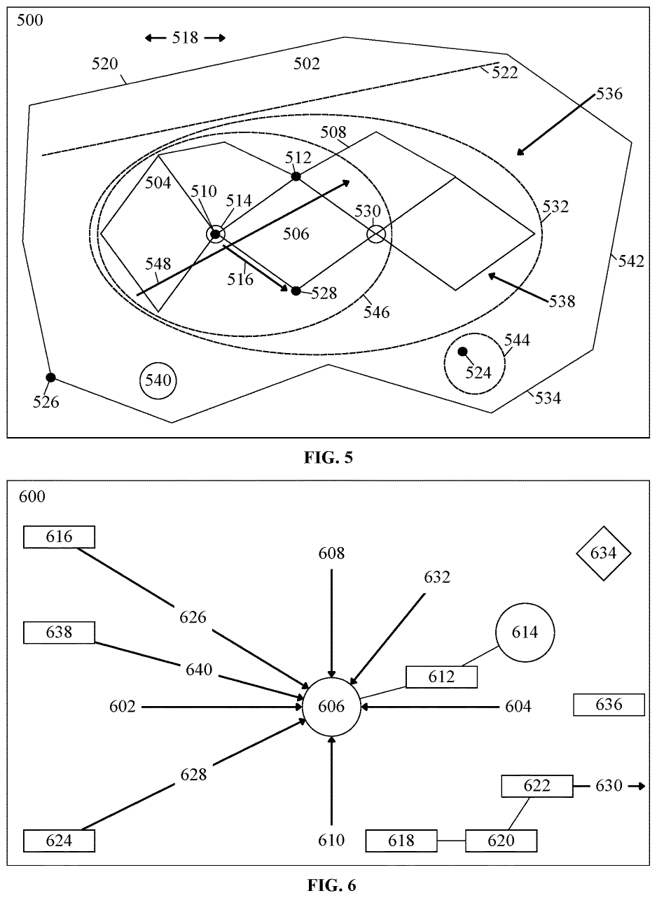

FIG. 5 illustrates a qubit fabric 500 including a Penrose tile region 502, kite tiles 504, dart tiles 506, tile edge interfaces 508, vertex stabilizer sites 510, a data-qubit site 512, an ancilla-qubit site 514, a syndrome path 516, a lattice pitch 518, a code patch boundary 520, a logical operator path 522, a defect feature 524, a boundary vertex 526, an interior vertex 528, an interface junction 530, a patch interior region 532, a patch edge segment 534, a readout access path 536, a control access path 538, a reserved inactive site 540, a logical boundary segment 542, a defect perimeter 544, a tile group 546, and a code-distance path 548. In this embodiment, the interface network is patterned so that tile edge interfaces 508 become the physical paths along which pattern-lock boundaries extend. The Penrose tile region 502 is therefore not merely a mathematical overlay. It is a layout framework for implementing the device architecture as an aperiodic qubit-supporting network.

The kite tiles 504 and dart tiles 506 create an aperiodic geometric arrangement that avoids simple translational repetition. This matters because a repeating lattice can impose repeated routing bottlenecks, repeated defect relationships, and repeated correlated-error opportunities. By contrast, the Penrose tile region 502 provides a self-similar but non-periodic framework in which interface paths, node degrees, patch boundaries, and logical traversal paths can be distributed more flexibly. In preferred embodiments, this can increase effective code distance per unit area and can suppress translationally correlated error structures. The functional representation d_code approx sqrt(N_data)*eta_tiling, with eta_tiling approx 1.3 in certain Penrose embodiments, captures one way this advantage may be expressed. The tile group 546 may represent a local cluster of kites 504 and darts 506 used as a repeated analysis unit, fabrication unit, or compiler-assigned logical unit.

At the vertex stabilizer sites 510, multiple tile edge interfaces 508 meet and provide natural locations for stabilizer-related structures and operations. The data-qubit site 512 and ancilla-qubit site 514 represent representative site assignments within the Penrose tile region 502. In some embodiments, many such data-qubit sites 512 and ancilla-qubit sites 514 are distributed across the fabric 500, with the illustrated labels showing example site types rather than the only instances. The syndrome path 516 represents one or more routes along which syndrome-related information can move or be extracted. The lattice pitch 518 may be selected according to die size, target qubit count, fabrication resolution, and control-line density. The code patch boundary 520, logical operator path 522, and defect feature 524 provide concrete structural support for logical patch formation, encoded operation, defect engineering, and patch-boundary control.

The boundary vertex 526 may identify a vertex located at or near the edge of a selected patch or fabric region, while the interior vertex 528 may identify a vertex located more centrally within the patch interior region 532. The interface junction 530 may identify a point where multiple tile edge interfaces 508 meet or branch in a way significant to routing, coupling, or stabilizer scheduling. The patch edge segment 534 may define a local portion of the code patch boundary 520, and the logical boundary segment 542 may define a portion of a logical boundary relevant to encoded operation or logical-path assignment. The readout access path 536 and control access path 538 provide representative access routes through which measurement and control resources can be brought into the fabric. The reserved inactive site 540 may represent a site withheld from active assignment because of routing, defect management, calibration, or policy reasons. The defect perimeter 544 may bound a defect feature 524, and the code-distance path 548 may represent a path used in evaluating or visualizing a code-distance metric across the fabric.

In representative embodiments, a relatively small demonstrator may use a larger lattice pitch 518 across a smaller die area, while a larger-scale implementation may use a smaller pitch to reach a higher qubit count on a larger die. The disclosure contemplates, for example, demonstrator-scale fabrics and larger fabrics approaching on the order of thousands of active sites. The cited relation d_code approx sqrt(5000)*1.3 approx 92 provides one example of how a larger Penrose-based fabric may be characterized. That value is illustrative and should not be understood to limit the invention to any particular qubit count, pitch, or die dimension. More generally, a compiler or controller may assign data-qubit sites 512, ancilla-qubit sites 514, reserved inactive sites 540, and defect features 524 according to objective rules that balance locality, routing burden, control-line access, and effective code distance.

FIG. 6 illustrates a stabilizer node 600 including an edge channel input 602, an edge channel output 604, a vertex junction 606, an X-stabilizer measurement path 608, a Z-stabilizer measurement path 610, a coupler 612, a readout resonator 614, a local controller line 616, a multiplexing element 618, an amplifier 620, an analog-to-digital interface 622, a timing controller 624, a bias input 626, a return path 628, a node output line 630, a calibration input 632, a filter element 634, a switching element 636, a local storage element 638, and a diagnostic line 640. This figure makes clear that the stabilizer architecture is not left at a purely abstract code-theory level. Instead, it is grounded in node-level physical structure and controller-connected circuitry.

At the vertex junction 606, one or more incoming and outgoing interface-supported modes represented by the edge channel input 602 and edge channel output 604 are brought into relationship with measurement and control structures. The X-stabilizer measurement path 608 and Z-stabilizer measurement path 610 may be separate, partially overlapping, time-multiplexed, or otherwise arranged to support distinct stabilizer-related functions. The coupler 612 may be capacitive, inductive, resonant, optical, superconducting, semiconducting, or hybrid. The readout resonator 614 may be used for measurement discrimination, spectral isolation, signal conditioning, or controller interfacing. The local controller line 616 brings node-directed control into the stabilizer node 600, and the bias input 626 may supply a local bias, tuning signal, calibration signal, or operating-point control.

The multiplexing element 618 allows multiple stabilizer nodes 600 to share part of the readout or control infrastructure. The amplifier 620 may operate at a cryogenic, near-cryogenic, or higher temperature stage depending on the implementation. The analog-to-digital interface 622 converts node-related outputs into machine-readable form, and the timing controller 624 schedules pulses, readout windows, calibration events, and measurement ordering. The return path 628 may provide a signal-return, ground-return, or complementary conduction path associated with node operation. The node output line 630 may carry a measurement result, conditioned analog signal, digitized result, or logical state output derived from the stabilizer node 600. Together, elements 602 through 630 provide concrete support for hardware-level stabilizer operation, controller interaction, and node-level signal processing.

The calibration input 632 may be used to inject a known calibration signal, reference pattern, test pulse, or tuning sequence into the node. The filter element 634 may attenuate noise, shape frequency response, suppress unwanted harmonics, or isolate selected signal bands. The switching element 636 may selectively connect or disconnect paths, resonators, couplers, or controller resources according to an operating mode or controller policy. The local storage element 638 may hold a temporary state, cached setting, calibration coefficient, or locally relevant control value used in operation of the node. The diagnostic line 640 may carry diagnostic information, fault indicators, confidence metrics, or debug signals to a controller or test system. In this way, the stabilizer node 600 is disclosed as a full subsystem capable of operation, calibration, failure isolation, and controller-supervised state management.

In some embodiments, the stabilizer node 600 may be used in multiple modes. In a measurement mode, the local controller line 616 may trigger a sequence causing the coupler 612 and readout resonator 614 to interact with the state of the node and produce a signal delivered through the amplifier 620 and analog-to-digital interface 622. In a calibration mode, the same structures may be exercised with a known input through the calibration input 632 to estimate gain, noise, drift, resonance shift, coupling strength, or line integrity. In a diagnostic mode, the timing controller 624 may apply a special schedule to isolate whether a failure arises from the edge channel input 602, edge channel output 604, multiplexing element 618, amplifier 620, filter element 634, switching element 636, or another part of the chain. The stabilizer architecture is therefore disclosed as an operable subsystem with defined behaviors rather than simply as a named node in a figure.

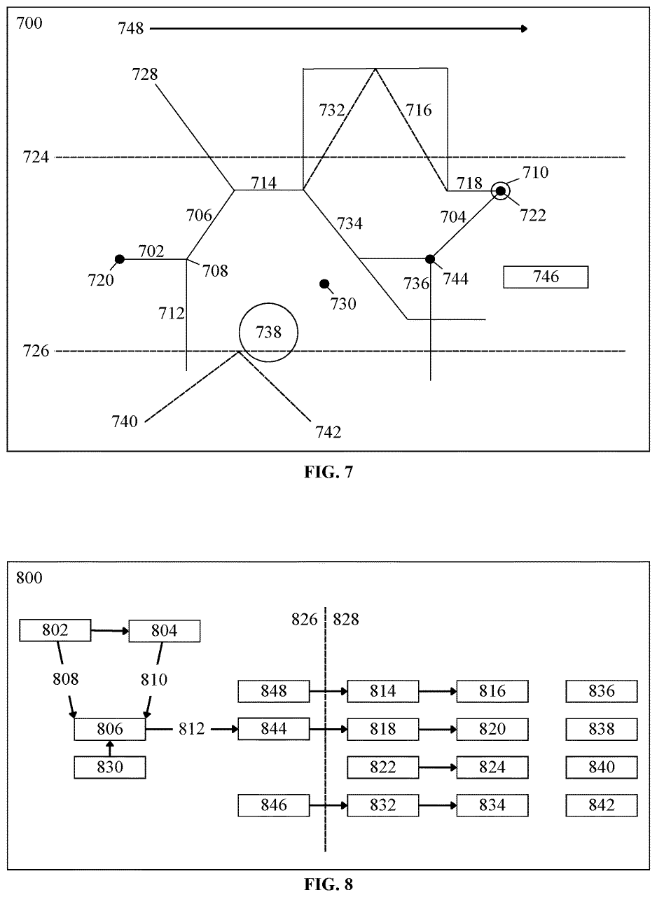

FIG. 7 illustrates a routing network 700 including a first interface segment 702, a second interface segment 704, a bend 706, a T-junction 708, a crossing 710, a branch output 712, an H-tree trunk 714, an H-tree branch 716, a mesh segment 718, a source node 720, a destination node 722, a readout bus 724, a control bus 726, a branch input 728, a path-selection node 730, a reserved path 732, an active path 734, a standby path 736, a loop path 738, a calibration path 740, an alternate path 742, a monitored junction 744, a path monitor 746, and a timing-distribution path 748. This figure demonstrates that the disclosed interface principle is not confined to isolated point-to-point channels. Instead, the same pattern-lock boundary architecture can be extended into a routing fabric that supports turns, branch points, crossings, hierarchic trees, meshes, and mixed-function transport paths distributed across a die, package, or module.

The first interface segment 702 and second interface segment 704 represent generic interface-defined transport segments that may be arranged linearly or non-linearly according to layout requirements. The bend 706 shows that an interface-supported boundary mode can follow a curved or angled path rather than only a straight path. The T-junction 708, branch input 728, and branch output 712 show that one interface path can divide into multiple paths for fan-out, path selection, traffic distribution, or localized routing. The crossing 710 shows that interface paths may intersect or overpass in a routing plan without reducing the disclosure to simple non-intersecting geometries. These features collectively support claim coverage directed to complex patterned networks rather than only single-boundary devices.

The H-tree trunk 714 and H-tree branch 716 illustrate one class of structured distribution topology useful when balanced path lengths, symmetric distribution, or organized fan-out are desirable. By contrast, the mesh segment 718 illustrates a more distributed topology that may provide redundancy, locality, alternate routes, or region-to-region connectivity. The source node 720 and destination node 722 identify generic endpoints of a transport path and may correspond to qubit sites, controller ports, readout locations, sensing structures, photonic couplers, memory regions, or other functional elements. The readout bus 724 and control bus 726 illustrate that the routing network 700 can be functionally partitioned so that different interface paths carry different traffic classes, although shared-path, dynamically assigned, and reconfigurable-bus embodiments are also contemplated.

The path-selection node 730 may represent a controller-addressable or structurally defined decision point at which a transport choice is made among multiple outgoing or incoming paths. The reserved path 732 may represent a path that is physically present but excluded from present use because of policy, calibration status, routing assignment, or fault handling. The active path 734 may represent the path currently selected for use, while the standby path 736 may represent a prevalidated fallback route held in reserve. The loop path 738 may provide a closed or partially closed path useful for interferometric operation, calibration, circulation, or local feedback. The calibration path 740 may be used preferentially during test or validation, and the alternate path 742 may provide a reroute option if another path is unavailable or lower ranked. The monitored junction 744 may be a location in the network at which status, quality, or flow is observed, and the path monitor 746 may be a device, sensor, or controller-coupled monitor that observes conditions at or near the monitored junction 744. The timing-distribution path 748 may provide a timing or synchronization route through the network.

From an operational standpoint, the routing network 700 may be used for qubit-to-qubit communication, classical-to-quantum control signaling, syndrome extraction, synchronization, distributed sensing, interferometric path definition, or transport to peripheral electronics. In some embodiments, routing priorities may be assigned by a controller such that time-critical readout traffic preferentially occupies one subset of interface segments while lower-priority control traffic occupies another subset. In other embodiments, particular paths may be reserved during calibration, validation, or fault-isolation procedures. Thus the routing network 700 is not merely a passive geometric pattern, but a transport architecture that can be assigned function, priority, and control consequences. In some embodiments, routing decisions in the network 700 are made using objective criteria such as path length, estimated loss, measured conductance, current node occupancy, thermal status, error status, reserved-path status, crossing count, bend count, or a predefined routing hierarchy.

FIG. 8 illustrates a quantum computing system 800 including a qubit die 802, a cryo-CMOS controller ASIC 804, an interposer 806, a control line bundle 808, a readout line bundle 810, a multiplexed address bus 812, a bias source 814, an analog front end 816, a digital processor 818, a memory 820, a firmware store 822, an external I/O 824, a cryostat stage 826, a higher-temperature stage 828, a package substrate 830, a clock source 832, a power-management block 834, a data link 836, a thermal sensor 838, a calibration control block 840, a verification block 842, a host interface 844, an update port 846, and a diagnostics bus 848. This figure shows that the disclosed architecture is intended for controller-coupled operation and is not limited to a passive material demonstration. The qubit die 802 may include one or more patterned interface networks, stabilizer sites, routing paths, transport lanes, or encoded regions as described elsewhere in this specification.

The cryo-CMOS controller ASIC 804 may perform site addressing, timing generation, multiplexing control, measurement coordination, bias scheduling, calibration management, and runtime enforcement of operational policies. The interposer 806 may mechanically and electrically couple the qubit die 802 and cryo-CMOS controller ASIC 804 while also redistributing pitch, routing signals, and accommodating thermal or packaging constraints. The control line bundle 808 may carry bias levels, pulse sequences, gate commands, addressing signals, or reset sequences, while the readout line bundle 810 may carry analog or digitized outputs representing transport measurements, stabilizer results, node states, calibration results, or fault indications. The multiplexed address bus 812 may reduce line count by allowing multiple sites or regions to share portions of the command path. The bias source 814 may provide one or more bias values used for operating-point selection, electrostatic tuning, calibration sweeps, transport-mode selection, lane enablement, measurement preparation, or reset behavior.

The analog front end 816 may filter, amplify, demodulate, or otherwise condition incoming signals before digital interpretation. The digital processor 818 may execute sequencing logic, routing logic, validation logic, exception handling, compiler-derived schedules, syndrome-processing routines, lane-allocation rules, or other runtime-control operations. The memory 820 may store dynamic runtime state, temporary measurement records, historical calibration values, lane reservations, patch assignments, routing tables, or validation logs. The firmware store 822 may retain executable control images, startup sequences, device definitions, compiler outputs, configuration profiles, and fallback-control packages. The external I/O 824 provides communication with host processors, laboratory equipment, validation workstations, fabrication-support systems, test infrastructure, local orchestration software, or remote supervisory systems.

The cryostat stage 826 and higher-temperature stage 828 illustrate that different subsystems may be operated at different temperatures. For example, the qubit die 802 may be positioned at a lower-temperature stage to support quantum operation while portions of the analog front end 816, digital processor 818, or other controller resources are placed at a somewhat higher but still controlled temperature. The package substrate 830 provides a structural and routing foundation for the integrated assembly. The clock source 832 may provide a timing reference for synchronized operation across the controller and active device. The power-management block 834 may regulate, distribute, condition, or gate power to different subsystems. The data link 836 may carry data between subsystems, packages, boards, or host resources. The thermal sensor 838 may provide temperature readings used for calibration, validation, or workload management. The calibration control block 840 may coordinate calibration cycles, update calibration coefficients, or supervise calibration-triggered decision logic. The verification block 842 may verify package authenticity, compatibility, integrity, validation status, or approval status before a control package, route assignment, or firmware image is accepted. The host interface 844 may provide communication with a supervisory computer or orchestration system, the update port 846 may receive firmware or package updates, and the diagnostics bus 848 may distribute or collect diagnostic information across the system.

From a control-logic standpoint, the system 800 may implement objective decision rules for operating the disclosed hardware. A site-selection rule may identify which stabilizer nodes are to be measured in a given cycle. A lane-allocation rule may determine which interface lanes are assigned to readout, control, or standby functions. A validation rule may compare measured conductance or resonance values against acceptance thresholds before allowing a transport path to be used in a live cycle. A thermal rule may relocate certain tasks away from structures whose local environment exceeds an operating threshold, based in part on data from the thermal sensor 838. A retry rule may reissue commands or redirect traffic when a first measurement or path-selection attempt fails. These operational details support prosecution-ready disclosure by showing how control is concretely exercised over the architecture and how the controller system is integrated with validation, update, verification, and thermal management functions.

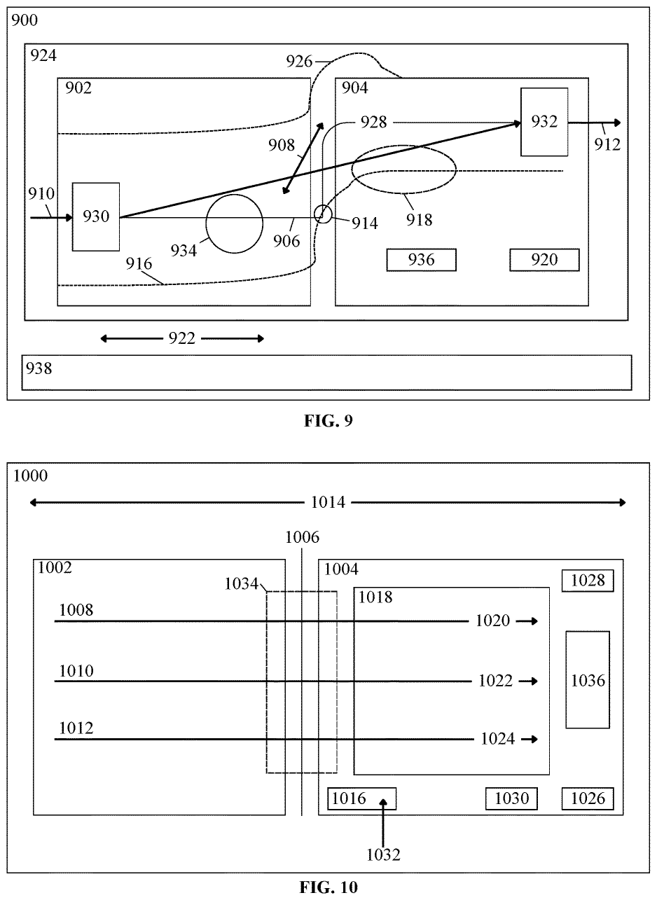

FIG. 9 illustrates a photonic device 900 including a first photonic crystal region 902, a second photonic crystal region 904, a photonic interface 906, a guided optical mode 908, an optical input 910, an optical output 912, a sharp bend 914, a bend radius 916, a coupling region 918, a transducer 920, a wavelength lambda at 922, a cladding 924, an optical confinement region 926, an optical propagation path 928, an input coupler 930, an output coupler 932, a defect cavity 934, a mode-conversion section 936, and a photonic support substrate 938. The first photonic crystal region 902 and second photonic crystal region 904 are arranged so that their differing pattern-charge values define the photonic interface 906. The guided optical mode 908 is then localized to that interface in a manner analogous to the electrical boundary modes described above, although the physical carriers and surrounding structures differ.

The optical input 910 may inject light from an on-chip source, off-chip source, fiber, waveguide, grating coupler, or another optical structure. The input coupler 930 may assist in coupling light into the first photonic crystal region 902 or directly into the photonic interface 906, depending on the layout. The optical propagation path 928 represents a representative path followed by the guided optical mode 908 along the photonic interface 906. The optical output 912 may direct light toward a detector, a subsequent waveguide, a transducer, or a network port, and the output coupler 932 may assist with efficient extraction of light from the active photonic region. In this way, the photonic embodiment is disclosed not merely as an abstract interface concept, but as a routed optical structure having defined ingress, egress, and guided propagation.

The sharp bend 914 and bend radius 916 illustrate that the guided optical mode 908 can traverse a non-linear path while maintaining guided behavior. In some embodiments, transmission through a bend of the type shown at 914 may exceed that of a conventional strip waveguide under comparable routing conditions, thereby supporting use in compact optical interconnect layouts. The optical confinement region 926 may represent the portion of the structure in which the guided optical mode 908 is substantially confined. The cladding 924 may be provided to improve confinement, environmental stability, mechanical protection, or packaging compatibility, and the photonic support substrate 938 may provide the structural and fabrication foundation for the photonic stack. These features support embodiments in which confinement, bend performance, and integration with surrounding package structures are all relevant to operation.

The coupling region 918 may transfer optical energy between the photonic interface 906 and another photonic or hybrid element. The transducer 920 may convert between optical signals and electrical signals, microwave signals, phononic signals, superconducting signals, or qubit-coupled excitations. The defect cavity 934 may provide a localized photonic feature used for resonance, field enhancement, coupling assistance, filtering, or mode interaction. The mode-conversion section 936 may represent a region in which one optical mode is transformed into another mode, into another guided structure, or into a form more suitable for transduction or coupling. In that regard, the photonic device 900 may operate as part of a quantum network node, a photonic readout path, a photonic bus, or an optical sensing arrangement. The wavelength lambda at 922 may be selected according to the intended application, and in preferred embodiments may be around 1.55 um for telecom-related use, although the invention is not restricted to telecom wavelengths.

Photonic validation may be performed using objective tests. A transmission test may compare measured throughput across the optical propagation path 928, including the sharp bend 914, against a reference path or against a conventional strip-waveguide control. A wavelength sweep may identify the operating band associated with the wavelength lambda at 922. A coupling-efficiency test may quantify performance through the coupling region 918, input coupler 930, output coupler 932, or transducer 920. A controller-assisted test may log transmission as a function of local temperature, local strain, or structural variation. These examples support later claims directed to validation methods and photonic-system operation without requiring that all embodiments use the same exact validation protocol.

FIG. 10 illustrates a multi-mode interface device 1000 including a first region 1002, a second region 1004, a boundary 1006, a first mode 1008, a second mode 1010, a third mode 1012, a total conductance chi_total at 1014, a mode separator 1016, a bus segment 1018, lane 1 at 1020, lane 2 at 1022, lane 3 at 1024, a lane combiner 1026, a lane splitter 1028, a lane monitor 1030, a lane control input 1032, a multi-mode boundary region 1034, and a multi-mode output node 1036. This embodiment is useful for showing that the invention is not limited to single-mode operation. Where the magnitude of DeltaJ is greater than one, multiple localized modes may exist at the boundary 1006, and those modes may be used as parallel transport channels or otherwise managed as distinct resources.

The first mode 1008, second mode 1010, and third mode 1012 represent one illustrative three-mode embodiment. In broad implementations, the precise number of modes may vary according to |DeltaJ|, the material system, the physical realization of the boundary, and the degree to which modes are separately resolvable. The multi-mode boundary region 1034 may represent a boundary zone having sufficient structure, width, or mode-supporting conditions to sustain multiple localized boundary modes. The total conductance chi_total at 1014 provides a concrete representation of the cumulative transport behavior, consistent with preferred embodiments in which chi_total=|DeltaJ|*e\hat{ }2/h. The mode separator 1016 may be a physical separator, a coupler network, a filtering structure, a controller-managed switching element, or another mechanism for selectively routing or distinguishing among the supported modes.

The bus segment 1018 and lanes 1020, 1022, and 1024 show that multi-mode boundaries can support multi-lane bus architectures. The lane combiner 1026 may combine traffic from multiple lanes into a shared path or downstream resource, and the lane splitter 1028 may divide incoming traffic into separate lanes. The lane monitor 1030 may observe lane status, quality, occupancy, error condition, or validation state. The lane control input 1032 may receive controller commands that enable, disable, reserve, prioritize, or reassign one or more lanes. The multi-mode output node 1036 may represent a downstream node at which one or more lanes terminate, merge, or are handed off to another network, controller block, sensor block, or interconnect structure.

In one embodiment, lane 1 at 1020 may be assigned to readout traffic, lane 2 at 1022 may be assigned to control traffic, and lane 3 at 1024 may be assigned to synchronization or redundancy. In another embodiment, all active lanes may carry the same class of data for increased throughput. In still another embodiment, one or more lanes may be kept in reserve and activated only after a validation event or fault event. A controller may assign lane usage according to static configuration data, dynamic workload conditions, measured lane quality, reserved-path status, thermal state, or other objective criteria. For example, if lane 2 at 1022 fails a validation threshold, the lane monitor 1030 may detect that state and the controller may reassign its traffic to lane 3 at 1024 through use of the lane control input 1032.

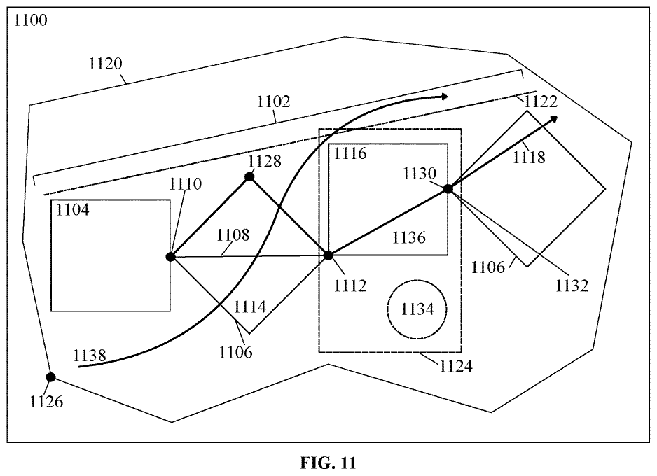

FIG. 11 illustrates an alternative quasicrystalline fabric 1100 including an Ammann-Beenker tile region 1102, a square tile 1104, a rhombus tile 1106, a tile edge interface 1108, a degree-four vertex 1110, a degree-eight vertex 1112, a data-qubit site 1114, an ancilla-qubit site 1116, a stabilizer path 1118, a patch boundary 1120, a logical path 1122, an error-correction region 1124, a boundary vertex 1126, an interior vertex 1128, an interface junction 1130, a routing segment 1132, a reserved defect region 1134, a patch interior region 1136, and a logical span path 1138. This embodiment shows that the disclosed pattern-lock architecture is not tied exclusively to Penrose tilings. The underlying principle is that aperiodic or quasicrystalline geometries can define patterned interface networks with advantageous connectivity and reduced translational repetition.

Within the tile region 1102, the square tile 1104 and rhombus tile 1106 define an alternative edge network whose tile edge interface 1108 carries the pattern-lock boundaries. The degree-four vertex 1110 and degree-eight vertex 1112 provide distinct local node types that may be used differently in stabilizer layouts, coupling layouts, measurement schedules, or logical-patch definitions. The data-qubit site 1114 and ancilla-qubit site 1116 may therefore be allocated according to vertex type, local degree, path availability, noise characteristics, or scheduling convenience. The boundary vertex 1126 and interior vertex 1128 distinguish representative edge-proximate and interior-proximate locations within the fabric. The interface junction 1130 may identify a junction at which multiple tile edge interfaces 1108 meet or branch in a way relevant to control, routing, or coupling.

The stabilizer path 1118, patch boundary 1120, logical path 1122, and error-correction region 1124 support fallback embodiments and narrower claim coverage directed to alternative quasicrystalline qubit fabrics and associated operations. The routing segment 1132 may represent a selected local route through the alternative fabric. The reserved defect region 1134 may identify a region deliberately withheld from active use because of defect handling, routing constraints, calibration status, or logical-patch policy. The patch interior region 1136 may identify the main interior area of a selected encoded patch. The logical span path 1138 may represent a path across the fabric used in evaluating or realizing a logical operation, encoded separation, or effective code distance. In this way, FIG. 11 provides support not only for the geometry itself, but also for its operational use as a qubit-supporting and routing-supporting architecture.

A compiler may compare a Penrose-based layout and an Ammann-Beenker-based layout for the same logical request and choose one according to objective criteria such as effective distance, line count, patch compactness, control conflict score, fabrication fit, reserved defect placement, or package-clearance constraints. Thus the invention supports alternative deployment models rather than a single mandated lattice. It also provides fallback support for narrower claims directed specifically to the alternative quasicrystalline embodiment. The distinction between FIG. 5 and FIG. 11 is therefore not merely artistic. It supports real implementation alternatives in which a designer or controller may choose one aperiodic topology over another based on measurable or rule-based engineering consequences.

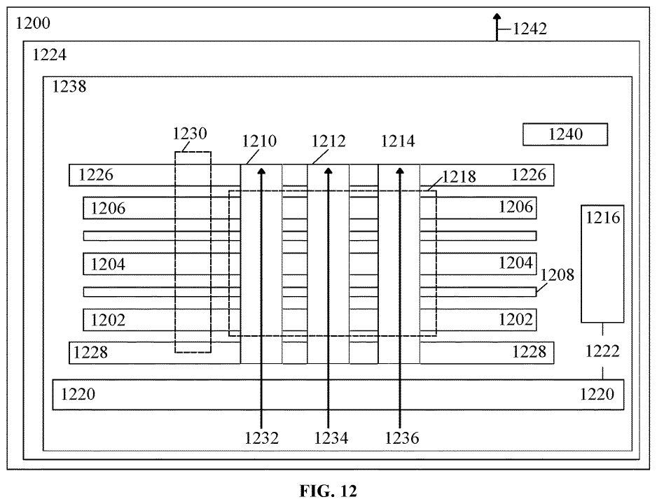

FIG. 12 illustrates a stacked device 1200 including a first patterned layer 1202, a second patterned layer 1204, a third patterned layer 1206, an interlayer dielectric 1208, a vertical via 1210, a first vertical connection 1212, a second vertical connection 1214, a stacked controller 1216, an encoded volume region 1218, a package substrate 1220, a thermal link 1222, an enclosure 1224, an upper routing layer 1226, a lower routing layer 1228, a layer-alignment region 1230, a vertical signal path 1232, a vertical readout path 1234, a vertical control path 1236, a stack support frame 1238, a heat-spreading element 1240, and an external package connection 1242. The stacked device 1200 demonstrates that the invention can be extended beyond a single patterned plane into a three-dimensional architecture. Each patterned layer 1202, 1204, and 1206 may contain interface paths, stabilizer sites, routing structures, or qubit-supporting regions arranged according to one or more disclosed tiling or network patterns.

The interlayer dielectric 1208 separates adjacent patterned layers while allowing controlled vertical interconnection through the vertical via 1210. The first vertical connection 1212 and second vertical connection 1214 represent representative paths through which boundary-related signals, control signals, measurements, synchronization, or logical couplings may pass between layers. The encoded volume region 1218 may represent a three-dimensional encoded region formed collectively by structures distributed across the first patterned layer 1202, second patterned layer 1204, and third patterned layer 1206. In some embodiments, vertical interconnections are used to build an encoded volume region 1218 with greater effective distance or connectivity than a strictly planar arrangement. In other embodiments, separate layers may specialize in different functions, such as one layer for transport, one layer for stabilizer logic, and one layer for controller-adjacent routing.

The upper routing layer 1226 and lower routing layer 1228 may provide additional structured paths for routing signals, boundary modes, measurements, or control resources above or below one or more active patterned layers. The layer-alignment region 1230 may provide a reference, mark, or structural region used to align the stacked layers during fabrication or bonding. The vertical signal path 1232 may represent a general vertical signal path, while the vertical readout path 1234 and vertical control path 1236 may identify more specialized vertical routes for readout and control, respectively. The stacked controller 1216 may be co-located above, below, beside, or otherwise integrated with the patterned layers to reduce signal distance or improve packaging density. These elements support claims directed to stacked routing, stacked control, and multi-layer encoded structures rather than only to a generic vertical stack.

The package substrate 1220 provides mechanical and electrical support for the stacked assembly. The thermal link 1222 may conduct heat to a sink or stage and may be designed to maintain acceptable operating conditions across the stack. The enclosure 1224 may provide environmental isolation, shielding, or cryogenic compatibility. The stack support frame 1238 may provide structural reinforcement, registration support, or protection for the stacked assembly. The heat-spreading element 1240 may distribute or dissipate heat generated by one or more portions of the stack, including the stacked controller 1216 or routing layers 1226 and 1228. The external package connection 1242 may provide access from the stacked device 1200 to a package-level, board-level, or system-level interconnect. From an enablement standpoint, FIG. 12 therefore supports three-dimensional device claims, three-dimensional code claims, vertical-interconnect claims, thermal-management claims, and stacked-controller claims.

Continuing with computer-readable-medium and design-automation embodiments, the disclosed system may include a non-transitory computer-readable medium storing machine-actionable artifacts used to design, fabricate, validate, and operate the device architectures described herein. Such artifacts may include mask-layout data, stack-definition data, process recipes, device-model data, routing definitions, compiler outputs, controller schedules, firmware images, validation criteria, and runtime-control packages. These stored items are not merely descriptive records. They may be directly consumable by fabrication tools, layout tools, process-control systems, simulation environments, controller environments, and validation systems. In one implementation, mask-layout data may specify trench geometries, interface segments, tile edges, contact regions, controller line routes, resonator placements, or packaging interfaces, while stack-definition data may specify permitted material combinations, thickness ranges, spacer options, and deposition orderings.

Device-model data may include SPICE models or equivalent circuit and behavior models for edge-channel structures, couplers, resonators, amplifiers, or controller interfaces. A stabilizer-tile compiler may map a logical code request onto a selected fabric layout, allocate data and ancilla locations, determine stabilizer sequencing, and emit line assignments or controller instructions. A routing synthesizer may assign transport paths, bus allocations, or fallback paths for a selected hardware layout. Controller firmware images may encode the timing, biasing, readout, calibration, retry, and failure-handling logic used during runtime. In software-operation terms, the system may distinguish among human-readable outputs, machine-actionable outputs, historical records, and current-use records so that the architecture is not reduced to a mere visualization pipeline but instead supports actual design, fabrication, validation, and control workflows.

In runtime terms, the design and control software may implement objective selection rules. For example, when multiple valid interface paths are available, the software may rank candidate paths by path length, estimated loss, reserved status, controller congestion, measured conductance margin, bend count, crossing count, or thermal headroom. When multiple stabilizer schedules are available, the software may choose the one with the lowest conflict score subject to timing constraints. When a measured device fails a validation rule, the runtime package may disable a lane, remap a stabilizer site, reduce bus usage to a validated subset, or redirect traffic through a fallback path. When a fabrication stack falls outside a preferred spacer-thickness range, the process-controller package may halt, flag, or rework the lot rather than silently proceeding. These examples provide concrete implementation substance for the software and medium embodiments.

The software and control artifacts may distinguish between presentation-only modifications and machine-semantic modifications. A displayed rerouting suggestion, highlighted path, updated visualization color, or reformatted validation report may change what a human operator sees without changing any operative hardware state. By contrast, a modified route table, updated threshold, revised compiler assignment, changed firmware image, or altered runtime-control package changes the actual machine-governing state of the system. Likewise, a historical record of a prior measurement does not by itself change active policy, while a current validated-state record may control whether a site, path, or lane is presently available. These distinctions are expressly disclosed so that storage, display, generation, validation, and execution can be clearly separated in later claim drafting and prosecution.

Continuing with system-level embodiments, the disclosed devices may be used as components of a fault-tolerant quantum computer, a topological quantum memory, a quantum network node, a quantum sensor, a mixed quantum-classical signaling architecture, or a classical low-loss interconnect system. In a fault-tolerant quantum computer embodiment, one or more patterned interface fabrics are combined with controller resources to implement encoded qubit operations, stabilizer extraction, logical routing, patch assignment, lane allocation, and fault handling. In a topological quantum memory embodiment, logical information is stored in the encoded structure defined by the patterned fabric and may be preserved, refreshed, or checked through controller-managed stabilizer operations. In a quantum network node embodiment, a photonic interface couples to a qubit-supporting fabric through a transducer or coupling region so that networked optical communication can be brought into a local encoded device environment.

In sensing embodiments, a boundary mode may be used as an interferometric arm, a phase-sensitive path, or a field-sensitive transport path, allowing the architecture to detect environmental changes, field perturbations, or local structural changes. In mixed-domain embodiments, some portions of the interface network may support quantum operation while others support classical transport, readout, or controller communication. In classical interconnect embodiments, the same boundary principle may be used to form repeater-free spans, branch structures, multi-lane buses, or high-density on-chip interconnect paths. The disclosure is thus structured to support apparatus claims, system claims, method claims, and computer-readable-medium claims all anchored to the same interfacial architecture. The fact that the same underlying boundary principle can be deployed across multiple domains does not require that every product implement every domain simultaneously.

Continuing with validation and reproducibility, the disclosed architectures may be subjected to objective validation procedures including cross-sectional microscopy, transport measurement, non-local measurement, photonic transmission measurement, controller-loop testing, lane-isolation testing, and qubit-fabric testing. A validation rule may require that a measured transport plateau remain within an acceptance tolerance before a given interface path is enabled for system operation. A boundary-sharpness rule may require that measured interface roughness remain below a threshold before multi-lane mode separation is trusted. A controller-validation rule may require successful execution of a timing schedule, readout sequence, retry routine, or compatibility check before a firmware package is approved for deployment. In this way, validation is disclosed not merely as observation, but as part of a machine-actionable workflow affecting whether and how the architecture is used.

A boundary-sharpness validation flow may involve cross-sectional microscopy or similar structural metrology to determine whether the physical transition region between adjacent pattern sectors is within an acceptable roughness or thickness range. In a representative validation flow, a cross-sectional sample may be taken from a device corresponding generally to the architecture 100, the boundary device region 200, or the stack embodiment 300, and one or more measurements may be taken to estimate transition width, interface continuity, spacer integrity, or layer order. A validation rule may require that the observed transition region remain below a threshold roughness or within a threshold dimensional band before the corresponding interface path is accepted for multi-mode or mission-critical use. This allows structural metrology to feed directly into enablement and deployment decisions.

A transport-validation flow may apply a multi-probe or four-probe measurement to a path coupled through the first contact 114 and second contact 116 or through equivalent structures. The measured result may be compared against an expected plateau value, against an allowed tolerance band, or against a historical calibration record. If the measured conductance remains within the acceptance band, the controller or validation system may classify the path as passed. If not, the path may be marked conditionally passed, degraded, or failed, depending on policy. This distinction is important because the same raw measurement may support different operational consequences in different systems, and because it separates observed data from controller acceptance.

A non-local or mean-free-path validation flow may test one or more interface segments using non-local measurement techniques or equivalent transport-characterization approaches to estimate whether a supported mode propagates across a desired span with sufficient integrity. The measured result may be used to estimate a mean-free path or another transport-quality metric. A routing system may then use that metric as one of the ranking factors when choosing among alternate paths. In this way, transport validation does not merely generate a laboratory result; it can feed directly into routing synthesis, lane enablement, standby-path selection, and controller runtime decisions. Similar validation logic may be used for loop paths 738, calibration paths 740, or alternate paths 742 in the routing network 700.

A photonic validation flow may test the photonic device 900 by launching light through the optical input 910, measuring transmission at the optical output 912, and comparing performance across one or more paths that include the sharp bend 914 and optical propagation path 928. A wavelength sweep may identify a preferred operating band associated with the wavelength lambda at 922. Additional tests may evaluate the efficiency of the coupling region 918, transducer 920, input coupler 930, output coupler 932, or defect cavity 934. A validation workflow may then mark a photonic route as approved, conditional, degraded, or unavailable, and that status may affect whether the route is included in a runtime control package or network-node configuration. Thus, photonic validation is expressly integrated into the same policy-aware framework as electrical and qubit-fabric validation.

A controller and firmware validation flow may test the cryo-CMOS controller ASIC 804, analog front end 816, digital processor 818, memory 820, firmware store 822, calibration control block 840, verification block 842, and diagnostics bus 848 as a coordinated subsystem rather than as isolated parts. A test cycle may confirm that a selected node can be addressed, that a scheduled measurement occurs within an allowed time window, that analog output is received and digitized correctly, that a classification result is stored properly, and that an update or retry path behaves as intended when the first attempt fails. Firmware validation may include checksum verification, version compatibility checks, timing compliance checks, and response-to-fault tests. These workflows support claims directed to controller-supervised operation and runtime control while also supporting auditability and reproducibility.

A compiler and design-package validation flow may compare generated outputs against structural rules and deployment constraints. For example, a generated Penrose-fabric assignment may be checked to confirm that data-qubit sites 512 and ancilla-qubit sites 514 do not conflict with reserved inactive sites 540, defect features 524, defect perimeters 544, readout access paths 536, or control access paths 538. A routing package may be checked to confirm that candidate paths do not exceed bus capacity, overuse monitored junctions 744, or cross excluded thermal zones. A stack-definition package may be checked to confirm that selected candidate material layers 302 and 304, candidate spacer layers 306, target thickness ranges 334, and thickness tolerance ranges 336 remain within supported windows. These procedures show that software outputs are treated as machine-governing artifacts subject to objective review before use.

Continuing with update behavior, the disclosed system may support multiple forms of revision without changing the underlying device category. A firmware update may change timing schedules, calibration thresholds, lane policies, or fallback behavior without altering the physical stack. A compiler update may produce different qubit-site assignments or routing choices for the same physical fabric. A process-recipe update may adjust deposition duration, anneal parameters, metrology checkpoints, or process-controller acceptance logic while still targeting the same architecture. A presentation-only update, such as a change in reporting format or visualization style, may leave all machine-semantic outputs unchanged. The disclosure is structured to support these distinctions because they can matter both for prosecution and for real system governance.

Continuing with provenance and authenticity, a fabrication output package may be associated with a stack definition, a material selection set, one or more recipe versions, and one or more validation results. A runtime control package may be associated with a compiler version, firmware version, policy version, and current validated-hardware state. In some embodiments, a device may be permitted to enter an active mode only if the provenance chain is complete and internally consistent. For example, a controller may reject a runtime package if it references a compiler version not approved for the detected hardware revision or if the package requests use of a path not present in the most recent validated topology. The verification block 842 may assist in enforcing such checks. This provides concrete support for authenticity, audit, approval-state, and reproducibility behavior.

Continuing with failure classification, not all deviations are treated equivalently. A hard structural failure may occur if a required layer is absent, a vertical via 1210 is open, a vertical signal path 1232 is broken, or a path is physically interrupted. A soft performance failure may occur if a path exists but fails to meet a preferred conductance, optical transmission, resonance, or timing threshold. A policy failure may occur if the hardware is functional but unavailable because it is reserved, out of certification, out of thermal range, or assigned to another task. A controller failure may occur if addressing, digitization, sequencing, verification, or memory operations do not conform to expected behavior. These distinctions are useful because they support specific fallback logic, repair logic, and claim differentiation rather than forcing all adverse events into a single undefined category.

Continuing with fallback logic, the controller may respond differently depending on the classified failure type. If a path undergoes a soft performance failure, the system may lower the path's ranking or remove it from preferred use while keeping it available for non-critical traffic or diagnostic purposes. If a lane in a multi-mode bus fails, the system may continue operating with the remaining lanes and recalculate bus capacity. If a site within a qubit fabric fails validation, the compiler may remap a logical patch to neighboring sites, redefine a patch interior region 532 or 1136, or mark a local defect region. If a firmware package fails compatibility review, the controller may revert to a known-safe prior image through the update port 846 while preserving the prior runtime state in audit records. These behaviors are concrete and support robust enablement.

Continuing with embodiment combinations and non-limiting scope, the material systems, layer choices, geometric layouts, tiling types, routing structures, controller placements, software packages, thermal arrangements, and validation rules described herein may be mixed and matched across embodiments unless technically incompatible. A photonic embodiment may be combined with a Penrose-based routing region. A stacked embodiment may use one Penrose layer and one Ammann-Beenker layer. A multi-mode interface may be incorporated into a classical bus, a quantum-readout bus, or a hybrid bus. A controller may be co-integrated in some embodiments and externally coupled in others. The invention is therefore not limited to the exact examples given, but rather includes disclosed variations and combinations that preserve the described pattern-lock interface principle and its associated system implementations.

Continuing with material-system embodiments, the disclosed first-region and second-region structures may be implemented using a wide range of materials and engineered stacks so long as adjacent regions are established with different pattern-charge values and a corresponding interface capable of supporting one or more localized boundary modes. Representative first-region materials include SiC, h-BN, Al2O3, and other insulating or semiconducting materials that can function as lower-pattern-charge regions in selected embodiments. Representative second-region materials include Bi2Se3, MoS2, graphene-hBN heterostructures, and other engineered or composite materials capable of functioning as higher-pattern-charge regions or otherwise as regions of differing pattern sector. These specific materials are illustrative and do not limit the disclosure to only the named compounds. Likewise, the candidate spacer layer 306 may be implemented using Al2O3, HfO2, van der Waals gaps, layered dielectric structures, amorphous oxides, or other interfacial materials capable of supporting the desired structural and transport conditions.

Pattern-charge engineering may be achieved in different ways depending on the platform. In some embodiments, the pattern-charge value of a region is primarily associated with the intrinsic properties of a selected material. In other embodiments, the effective pattern-charge value is established or shifted through heterostructure design, layer sequence, doping, strain engineering, moire engineering, compositional tuning, structural symmetry control, local field conditioning, or combinations of those approaches. The disclosure therefore supports both embodiments in which a material naturally provides the desired pattern sector and embodiments in which the pattern sector is engineered through device design. This is important from a prosecution standpoint because it provides written-description support for later claims directed either to particular materials or to broader region-engineering approaches.

The spacer may likewise be selected according to the intended implementation. In preferred embodiments, the candidate spacer layer 306 is an oxide, dielectric, layered material, or van der Waals gap that supports controlled interface formation between adjacent regions. In some embodiments, the spacer primarily controls geometric separation. In other embodiments, the spacer also affects interfacial sharpness, local field environment, tunneling behavior, confinement behavior, or interface stability. In still other embodiments, the spacer may be patterned, locally omitted, or replaced by a direct-contact region so long as the resulting boundary remains capable of supporting the disclosed interface-localized modes. The selected spacer thickness d at 310 may be compared against the target thickness range 334 and thickness tolerance range 336 before a device is accepted for later-stage processing or deployment.

Continuing with transport relations and operational consequences, the disclosed boundary architecture supports objective transport behavior tied to the engineered interface rather than to ordinary bulk conduction. In preferred embodiments, each supported mode contributes chi_edge=e\hat{ }2/h, and the total conductance for a multi-mode interface can be expressed as chi_total=|DeltaJ|*e\hat{ }2/h. In practical measurements, the observed value may appear as a conductance plateau or quasi-plateau within a tolerance determined by fabrication quality, measurement setup, thermal noise, disorder, coupling parasitics, or other non-idealities. Accordingly, the disclosure does not require that every embodiment present an ideal symbolic result in every measured sample. Rather, it provides a concrete physical mechanism linking interfacial design to observable transport behavior and further ties that behavior to controller-governed system use.

The disclosed transport behavior is useful not only as a physics signature but also as an engineering resource. A validated edge channel 112 may be used as a communication path, a bus segment, a stabilizer-associated transport segment, a sensing path, or a calibration structure. In some embodiments, a controller may compare measured transport behavior against a threshold before placing a given interface path into service. For example, if a measured path conductance falls below a configured fraction of an expected plateau, the controller may mark the path as degraded and reassign traffic elsewhere, such as from an active path 734 to a standby path 736 or alternate path 742. If the path passes validation, the controller may enable it for readout, control signaling, logical routing, or other active use. These operational rules tie the physical transport effect to machine-actionable system behavior rather than leaving the conductance relation as an isolated scientific observation.

Continuing with temperature and field robustness, some embodiments may remain functional across a range of temperatures and magnetic-field conditions. Preferred benchmark discussions may refer to operation consistent with an edge-gap relation such as edge_gap>k_BT, and projected higher-temperature embodiments may be discussed with reference to edge_gap>k_B*300 K approx 26 meV. Those statements are explanatory and do not limit broader embodiments to a single target operating point. In some implementations, temperature and magnetic-field values are better understood as validation conditions, design targets, or benchmark examples rather than mandatory claim limitations. This layered treatment preserves broad support while still disclosing concrete performance-oriented embodiments and projected future embodiments.

Continuing with Penrose-fabric operation in greater detail, the qubit fabric 500 may be operated so that selected vertex stabilizer sites 510 perform repeated stabilizer-related measurements under controller supervision. Data-qubit sites 512 may hold encoded quantum information, while ancilla-qubit sites 514 may serve measurement-supporting or syndrome-extraction functions. The syndrome path 516 may represent a logical or physical path through which syndrome information is gathered, transferred, aggregated, or processed. In some embodiments, the code patch boundary 520 defines the edge of a logical patch and may also delimit a region for controller assignment, thermal management, validation scope, or isolation from neighboring patches. The logical operator path 522 may correspond to a path along which a logical operation is represented physically within the fabric, and the defect feature 524 together with the defect perimeter 544 may be used to create, move, or manage logical structures, excluded regions, or specialized correction areas.

In some embodiments, site assignment within the Penrose fabric is performed using ordered decision rules rather than ad hoc selection. A compiler or controller may first identify all candidate boundary vertices 526 and interior vertices 528 satisfying a degree criterion, then exclude candidates reserved for routing, package-clearance, calibration, or defect-management reasons, then assign a first subset as data-qubit sites 512 and a second subset as ancilla-qubit sites 514 to satisfy locality and timing constraints. A patch-construction rule may maximize effective code distance subject to a fixed area budget, or minimize controller-line crossings subject to a fixed minimum distance target. A logical-path rule may select a route across the fabric that avoids reserved inactive sites 540 and minimizes overlap with high-traffic syndrome paths 516 or control access paths 538. These operational details support objective implementation and reduce the risk of the disclosure being characterized as purely aspirational.

The patch interior region 532 and patch edge segment 534 may be used to distinguish interior operations from edge operations within a selected encoded patch. In some embodiments, particular stabilizer schedules are applied preferentially at the patch edge segment 534 to manage boundary effects, while different schedules are used in the patch interior region 532. The readout access path 536 may be reserved for measurement extraction during certain cycles, while the control access path 538 may be reserved for controller-driven biasing, timing, or switching operations. The logical boundary segment 542 and code-distance path 548 may be used by a compiler, controller, or validation tool to estimate whether a selected patch satisfies a target logical separation or protection criterion. Thus, FIG. 5 supports not only a static tiling picture but also a full operational framework for assignment, scheduling, validation, and encoded control.

Continuing with stabilizer-node operation in greater detail, the stabilizer node 600 may be used in multiple modes. In a measurement mode, the local controller line 616 may trigger a sequence causing the coupler 612 and readout resonator 614 to interact with the state of the node and produce a signal delivered through the amplifier 620 and analog-to-digital interface 622. In a calibration mode, the same structures may be exercised with a known input through the calibration input 632 to estimate gain, noise, drift, resonance shift, coupling strength, or line integrity. In a diagnostic mode, the timing controller 624 may apply a special schedule to isolate whether a failure arises from the edge channel input 602, edge channel output 604, multiplexing element 618, amplifier 620, filter element 634, switching element 636, local storage element 638, or another part of the chain. The node output line 630 and diagnostic line 640 may carry different kinds of outputs depending on whether the node is in a measurement, calibration, or diagnostic state.

Continuing with controller-managed scheduling, the system may operate on repeated cycles in which groups of nodes are measured according to a timing table, bus-allocation table, and conflict-avoidance policy. A timing rule may require that neighboring nodes not be measured simultaneously if doing so would exceed available bus capacity or create unacceptable coupling interference. A multiplexing rule may limit how many nodes are connected through a given multiplexing element 618 at once. A retry rule may repeat a measurement if a signal is out of range or if a line-integrity check fails. A fallback rule may substitute a neighboring verified node or path if a selected node is unavailable. These examples are representative and show that the disclosed controller architecture naturally supports ordered, objective decision logic that can be implemented through firmware, runtime packages, and machine-readable scheduling artifacts.

Continuing with routing-network control in greater detail, the routing network 700 may be managed in a way that distinguishes between transport availability and policy acceptance. A given path may be physically capable of carrying a boundary mode but still be excluded from current use because it is reserved, under test, temporarily degraded, thermally stressed, or currently assigned to another traffic class. Thus, detection of an available path is distinct from the decision to activate that path. Similarly, observation of a transport plateau is distinct from controller acceptance of that path for operational use. The specification deliberately preserves these distinctions so that later claims can separately address detection, validation, selection, and control. The path monitor 746 and monitored junction 744 are useful in embodiments where routing status, local path quality, or branch occupancy is actively observed during operation.

A routing decision for the network 700 may proceed in stages. First, the controller may generate a candidate set of available paths connecting the source node 720 to the destination node 722. Second, the controller may remove paths that traverse reserved paths 732, invalidated segments, or regions under calibration, such as those associated with the calibration path 740. Third, the controller may rank the remaining paths by an objective function, such as path length, expected conductance margin, bus congestion, number of crossings 710, number of bends 706, monitored-junction load at 744, or branch conflict score at the path-selection node 730. Fourth, the controller may choose the highest-ranked path that also satisfies current scheduling rules. If no such path exists, the controller may defer the operation, split the traffic, downgrade the traffic class, or invoke a fallback topology such as an H-tree path through the H-tree trunk 714 and H-tree branch 716. This form of ordered logic provides concrete support for path-selection embodiments, alternate-path embodiments, and timing-distribution embodiments associated with the timing-distribution path 748.

Continuing with cryo-CMOS and mixed-temperature integration, the system 800 may separate functions by temperature stage. In one embodiment, the qubit die 802 and the most noise-sensitive analog resources are placed near the cryostat stage 826, while the digital processor 818 and portions of the memory 820 are placed at the higher-temperature stage 828. In another embodiment, the cryo-CMOS controller ASIC 804 performs near-device multiplexing and first-level control near the lower-temperature stage, while higher-level scheduling and firmware updates are issued from resources farther away through the host interface 844 or update port 846. Such architectures reduce the burden on long-distance line counts and can improve latency, while also supporting practical packaging. The disclosure therefore supports local, remote, and split-controller embodiments as well as staged thermal-management embodiments based on the thermal sensor 838 and power-management block 834.

Continuing with firmware and runtime packages, the firmware store 822 may hold multiple control images corresponding to different operating modes. A first image may support validation or bring-up, a second image may support steady-state encoded operation, and a third image may support recovery or degraded-mode operation. A runtime package may specify which line bundles are active, which stabilizer sites are mapped to which buses, which lanes are enabled, what thresholds govern pass-fail validation, and how fallback rules are to be applied. Because those artifacts can be stored, loaded, versioned, verified, and executed, the disclosure supports claims directed to machine-actionable firmware and software embodiments and not merely to static documentation. In some embodiments, loading of a package is conditioned on successful verification by the verification block 842 and compatibility with the detected hardware and provenance state.

Continuing with photonic operation in greater detail, the photonic device 900 may serve as an interconnect between separated device regions, as an interface to off-chip optical systems, or as a component of a quantum network node. In a representative embodiment, light introduced at the optical input 910 through the input coupler 930 is guided along the photonic interface 906 through the optical propagation path 928, turns through the sharp bend 914 having bend radius 916, and exits at the optical output 912 through the output coupler 932 with lower backscatter than would be expected for an ordinary waveguide bend of comparable compactness. In another embodiment, the guided optical mode 908 is not merely transmitted to an output but is delivered to the coupling region 918 and transducer 920 for domain conversion. The optical confinement region 926, cladding 924, defect cavity 934, and mode-conversion section 936 may cooperate to shape mode behavior, localize fields, enhance coupling, or tailor the interface to a selected application. The photonic support substrate 938 may support fabrication, packaging, and thermal control of the photonic structure.

The photonic device 900 may therefore support several distinct operating roles. In a readout role, the guided optical mode 908 may carry information from a local device region to an optical detector or intermediate processing stage. In a network role, the transducer 920 may convert between optical signals and another domain, including electrical, microwave, phononic, superconducting, or qubit-coupled excitations, so that the photonic interface 906 forms part of a larger quantum-network-node architecture. In a sensing role, changes in transmission, phase, coupling, resonance, or field localization may be used to detect a condition of interest. In a validation role, the photonic structure may be used to confirm whether a fabricated interface exhibits the expected low-backscatter routing behavior. Thus, the photonic embodiment is disclosed as a practical device architecture with multiple deployable modes rather than as a theoretical optical analogue only.

Continuing with higher-|DeltaJ| operation, the multi-mode interface device 1000 may implement static or dynamic lane assignment using the first mode 1008, second mode 1010, third mode 1012, lane 1 at 1020, lane 2 at 1022, and lane 3 at 1024. In a static embodiment, the three lanes are assigned permanently to different traffic categories or functions. In a dynamic embodiment, the controller reassigns the lanes according to workload, measured lane quality, reserved capacity, or error state. The lane combiner 1026 and lane splitter 1028 may be used to merge or divide traffic among the lanes, and the lane monitor 1030 may observe lane quality, occupancy, or validation state over time. The lane control input 1032 may accept commands that enable, disable, prioritize, reserve, or reconfigure the lanes. The multi-mode boundary region 1034 may support the simultaneous existence of multiple localized modes, and the multi-mode output node 1036 may provide a structured handoff point to another bus, controller path, sensing path, or processing block.

In one example, lane 1 at 1020 may be assigned to readout traffic, lane 2 at 1022 may be assigned to control traffic, and lane 3 at 1024 may be assigned to synchronization or redundancy. In another example, all active lanes may carry the same class of data for higher throughput. In still another example, one or more lanes may be kept in reserve and activated only after a validation event or fault event. If lane 2 at 1022 fails a threshold test, the lane monitor 1030 may identify the degradation and the controller may use the lane control input 1032 to redirect that traffic through lane 3 at 1024, optionally by way of the lane combiner 1026 or lane splitter 1028. The lane assignments may be recorded in a runtime package, updated during recalibration, and checked against current policy before activation. These embodiments provide concrete support for higher-bandwidth and multi-lane interconnect use while preserving objective control logic.

Continuing with classical interconnect use, a boundary-based bus may be used to carry digital or analog signals between processing regions, memory resources, sensor blocks, controller resources, or mixed-function modules. The advantage is that the disclosed interface architecture may provide lower loss, reduced repeater dependence, or improved thermal behavior relative to ordinary metallic routing in selected implementations. A controller may validate bus quality before enabling mission-mode traffic, may reserve one lane for calibration, or may monitor a path over time for degradation. Thus, the disclosure supports classical interconnect embodiments without collapsing them into the quantum embodiments or vice versa. The same interfacial principle can support both while the system-level role remains distinct. In some embodiments, a classical bus implemented through the routing network 700 or multi-mode interface device 1000 may coexist with conventional metal routing, and a controller may choose between them according to latency, energy, temperature, or error criteria.

Continuing with Ammann-Beenker operation in greater detail, the alternative quasicrystalline fabric 1100 may be selected when its vertex classes, local degrees, or path geometry better match a desired measurement schedule, coupling arrangement, or routing budget. The square tile 1104 and rhombus tile 1106 define the local geometry of the tile region 1102, while the tile edge interface 1108 defines the paths along which pattern-lock interfaces extend. The degree-four vertex 1110 and degree-eight vertex 1112 provide distinct local node types that may carry different stabilizer, routing, or coupling significance. The data-qubit site 1114 and ancilla-qubit site 1116 may therefore be assigned according to vertex degree, noise environment, path accessibility, local routing load, or controller policy. The boundary vertex 1126 and interior vertex 1128 may be used to distinguish edge-related and interior-related scheduling or patch logic within the alternative fabric.

The stabilizer path 1118, patch boundary 1120, logical path 1122, error-correction region 1124, interface junction 1130, routing segment 1132, reserved defect region 1134, patch interior region 1136, and logical span path 1138 provide a fuller operational framework for the Ammann-Beenker embodiment. A compiler may compare a Penrose-based layout and an Ammann-Beenker-based layout for the same logical request and choose one according to objective criteria such as effective distance, line count, patch compactness, control conflict score, fabrication fit, reserved defect placement, or package-clearance constraints. A routing synthesizer may prefer the routing segment 1132 of the alternative fabric in one use case but select a Penrose-derived path in another. In some embodiments, the logical span path 1138 is used to estimate encoded separation or a logical operator extent, while the reserved defect region 1134 is withheld from active use for defect management or routing reasons. Thus the alternative quasicrystalline embodiment is not merely an alternate drawing style, but a distinct implementation choice with measurable engineering consequences.

Continuing with three-dimensional use, the stacked device 1200 may implement several different policies. In one policy, the first patterned layer 1202, second patterned layer 1204, and third patterned layer 1206 each hold similar encoded structures and the vertical via 1210, first vertical connection 1212, and second vertical connection 1214 create interlayer logical or routing links. In another policy, one layer serves primarily as a transport or bus layer, another as a stabilizer layer, and another as a controller-adjacent layer. In still another policy, the encoded volume region 1218 is defined across the layers collectively and is managed as a single encoded volume. The upper routing layer 1226 and lower routing layer 1228 may provide additional routing resources above and below the main patterned layers, and the vertical signal path 1232, vertical readout path 1234, and vertical control path 1236 may distribute distinct traffic classes between layers. These alternatives provide strong support for stacked embodiments without requiring all stacked devices to behave identically.

The layer-alignment region 1230 may support accurate registration of the first patterned layer 1202, second patterned layer 1204, and third patterned layer 1206 during fabrication, bonding, or assembly. The stack support frame 1238 may reinforce the assembly structurally or provide mechanical registration. The heat-spreading element 1240 may distribute heat generated by one or more active layers, routing layers, or the stacked controller 1216, and the thermal link 1222 may conduct that heat toward a sink or stage. The package substrate 1220 and enclosure 1224 may provide mechanical support, electrical interfacing, environmental isolation, shielding, and thermal compatibility. The external package connection 1242 may provide access from the stacked device 1200 to a package-level, board-level, or system-level interconnect. These packaging and thermal elements matter because they help define whether a three-dimensional embodiment remains manufacturable and operable in a deployed system rather than only in a proof-of-concept setting.

Continuing with package and thermal management more generally, the package substrate 1220, thermal link 1222, enclosure 1224, stack support frame 1238, heat-spreading element 1240, package 124, and package substrate 830 may be selected according to whether the device is intended for cryogenic quantum operation, mixed-temperature operation, photonic operation, flexible operation, or other specialized environments. In some embodiments, heat is preferentially removed from controller-adjacent regions while protecting temperature-sensitive active boundary structures. In other embodiments, a package is selected to support optical alignment, low-vibration operation, or field shielding. In still other embodiments, the thermal sensor 838 feeds temperature data into a controller rule that changes lane allocation, patch activity, or routing priorities when a thermal threshold is exceeded. These disclosures provide substance for packaging, thermal-management, and system-governance claim themes.

Continuing with formal verification support, certain mathematical relations and design rules associated with the disclosed architecture may be supported by formalized results, including standard_interface, conductance_quantised, conductance_positive, phi_tiling_aperiodic, phi_tiling_ratio, spacer_from_phi, spacer_positive, and parameter_free. Those formalized results may be used as design aids, consistency checks, or validation resources during compiler execution, stack selection, routing synthesis, documentation generation, or package verification. However, the operability of the disclosed devices is not limited to embodiments in which formal verification artifacts are present at runtime or claimed expressly. The formalized relations support the disclosure but do not cabin the invention to one software environment or one proof workflow. They instead provide additional technical grounding for the preferred equations, tiling relations, and spacer-selection logic already described.

Continuing with worked-example support, the disclosed architecture contemplates example embodiments including a single-edge-channel proof-of-concept stack, a Penrose-tiled demonstrator, a larger qubit fabric with controller integration, a photonic topological waveguide, a lossless or low-loss on-chip bus, and a projected room-temperature embodiment. A proof-of-concept stack may use the first candidate material layer 302, candidate spacer layer 306, and second candidate material layer 304 to establish an interface validated through contacts 114 and 116. A Penrose demonstrator may use the qubit fabric 500 with selected data-qubit sites 512 and ancilla-qubit sites 514. A larger-scale embodiment may couple the qubit die 802 to the cryo-CMOS controller ASIC 804 through the interposer 806 and related line bundles. A photonic example may use the photonic interface 906, sharp bend 914, and transducer 920. A bus example may use the routing network 700 or multi-mode interface device 1000. A projected room-temperature example may use an edge-gap design target associated with edge_gap>k_B*300 K approx 26 meV. These examples provide multiple fallback paths for claim drafting while preserving a consistent architectural core.

Each example may be classified as experimental, simulated, projected, or prophetic depending on the actual record. An experimental example is one supported by actual physical build and measurement. A simulated example is one supported by computational or model-based prediction but not yet necessarily by physical fabrication. A projected or prophetic example is one disclosed as a forward-looking implementation grounded in the disclosed principles but not yet necessarily reduced to practice. These classifications may affect whether a controller accepts a path for mission operation, whether a design package is marked production-ready, or whether certain benchmark values are treated as measured values or target values. This distinction reduces ambiguity, supports accurate prosecution positioning, and preserves credibility regarding what has and has not yet been demonstrated in a given implementation.

Continuing with failure handling and lifecycle behavior, the system may treat different types of failure differently over time. A fabrication-level failure, such as an out-of-range spacer thickness at 310 relative to the target thickness range 334 or thickness tolerance range 336, may cause a lot or die to be rejected or reworked through the rework branch 438. A transport-level failure, such as inadequate measured conductance through an edge channel 112 or a lane 1020, 1022, or 1024, may cause a path to be disabled or demoted while leaving the remainder of the die active. A controller-level failure, such as a failed timing routine, failed verification block 842 check, or incompatible firmware image in the firmware store 822, may cause rollback to a prior image or transition to a degraded mode. A lane-level failure in a multi-mode interface may simply reduce the number of active lanes while preserving operation of the others. By disclosing these distinctions, the specification supports robust system behavior and provides substance against criticisms of under-explained failure handling.

Continuing with embodiment combinations and deployment flexibility, a Penrose-based qubit fabric may be combined with a multi-mode bus, a photonic coupling path, a stacked controller, or an alternative validation workflow. An Ammann-Beenker region may coexist with a Penrose region on the same die or in the same package. A stacked architecture may include a photonic layer and an electrical boundary layer. A controller may use both local cryogenic resources and remote host resources. A design and control system may emit both fabrication output packages and runtime control packages. The invention therefore supports local embodiments, distributed embodiments, hardware embodiments, software embodiments, online embodiments, offline embodiments, batch embodiments, runtime embodiments, and verification embodiments without requiring a separate continuation-in-part to add those categories later. The disclosure is intentionally structured to permit these combinations while maintaining stable terminology and objective technical grounding.

Continuing with definitional clarity for mixed-domain embodiments, the same physical interface principle may be instantiated in an electronic transport embodiment, a qubit-fabric embodiment, a photonic embodiment, a hybrid superconducting embodiment, a sensing embodiment, or a classical interconnect embodiment without requiring that the same device perform all such functions simultaneously. In some implementations, a device is fabricated and used for one function only. In other implementations, a single die, stack, or package supports more than one function, such as a qubit fabric coupled to a photonic interface, a boundary-mode bus used for both readout and classical control support, or a stacked assembly in which one patterned layer is dedicated primarily to transport while another supports encoded storage or controller-adjacent routing. The disclosure therefore supports both single-purpose and multi-purpose implementations and does so without changing the underlying description of adjacent regions having different pattern-charge values and an interface that supports one or more localized boundary modes.

Continuing with distinctions among required and optional features, the presence of adjacent regions having different pattern-charge values and a corresponding interface capable of supporting one or more localized boundary modes is central to the disclosed architecture. By contrast, features such as the gate structure 118, dielectric layer 120, passivation layer 128, passivation cap 322, multiplexing element 618, amplifier 620, transducer 920, stacked controller 1216, verification block 842, or particular compiler and firmware artifacts may be optional in some embodiments and preferred in others. Likewise, the preferred phi-based relations, including X_opt=phi/pi, d_norm=(phi/pi)\hat{ }(½), and d=d_norm*l_ref, provide strong support for narrower preferred implementations but are not required in every broad embodiment so long as the structure still establishes the disclosed interfacial behavior. This distinction is important because it preserves broad written-description support while still identifying concrete narrower embodiments that may later be claimed or relied upon during prosecution.

Continuing with support for distributed implementation, one portion of the disclosed functionality may be implemented in hardware local to the active device while another portion is implemented remotely, off-chip, or at a different system layer. For example, a local controller may carry out timing and readout execution through the local controller line 616, timing controller 624, calibration control block 840, and diagnostics bus 848, while a remote system reached through the host interface 844 or external I/O 824 determines route assignments, patch remapping, package approval state, or update policy. A process controller 424 may generate or approve fabrication actions prior to manufacture, while a runtime package later governs the already fabricated hardware. A design and control system may therefore be distributed across fabrication tools, local controllers, package-level logic, host computers, and supervisory systems while remaining within the scope of the present disclosure.

Continuing with support for offline and online workflows, some embodiments may rely heavily on offline computation and predetermined packages, while other embodiments may rely heavily on online adaptation. In an offline-oriented embodiment, a logical-qubit mapper, routing synthesizer, stack-definition package, and firmware generator may fully determine a runtime package before deployment, and the runtime system may primarily execute that package. In an online-oriented embodiment, the runtime system may continuously adapt site assignments, path selections, lane assignments, validation thresholds, or patch definitions in response to current measurements. Many practical systems may use a hybrid approach in which an initial package is generated offline and then selectively modified online in response to validation data, drift, faults, workload changes, or thermal signals from the thermal sensor 838. This distinction is useful because it supports later claims directed both to predeployment artifacts and to active runtime machine behavior.

Continuing with support for different operational granularities, the disclosed architecture may be managed at the level of a single interface segment, a lane, a node, a patch, a patterned region, a die, a stack, a package, or an entire networked system. A validation result may therefore apply to one lane 1020, 1022, or 1024 but not another, to one patch interior region 532 or 1136 but not the full die, or to one stacked device 1200 but not a neighboring die in a module. Similarly, a control action may enable a single site, reserve an entire bus, disable one branch of a routing network, or reassign a logical patch across a broader region. This granularity support is useful because it provides written-description basis for claims and arguments directed to local control as well as region-level or system-level control. It also reinforces that the disclosed runtime packages and validation logic operate on real machine-governed units rather than on undefined abstractions.

Continuing with interface-shape flexibility, the disclosed interface is not limited to one morphological form. It may be linear, arcuate, branched, tessellated, looped, nested, folded, stacked, intersecting, partially enclosed, or distributed across multiple regions. The route by which the first region and second region come into adjacency may therefore vary substantially across embodiments. In some implementations, the interface is defined through lithographically patterned trenches, including structures associated with the isolation trench 130 or trench opening 324. In other implementations, it is defined through deposited sidewalls, transferred layers, bonded regions involving the bonding region 134, or photonic-region boundaries such as the photonic interface 906. This flexibility is part of the enablement because it shows that the invention is directed to the engineered interfacial relationship rather than to only one fabrication geometry.

Continuing with dimensional flexibility, the disclosed layers, regions, pitches, gaps, trench widths, bend radii, via dimensions, routing spans, and package scales may vary according to the selected application. A small demonstrator may use dimensions chosen to maximize fabrication tolerance and observability. A denser qubit fabric may use smaller features to increase site count and reduce footprint. A photonic embodiment may use dimensions selected according to optical wavelength and confinement criteria associated with the optical confinement region 926 and bend radius 916. A flexible embodiment may use dimensions selected to reduce strain concentration. A stacked embodiment may use interlayer spacing selected according to dielectric strength, thermal transfer, and via fabrication constraints associated with the interlayer dielectric 1208 and vertical via 1210. These variations remain within the scope of the disclosure so long as the resulting structure still embodies the disclosed pattern-lock interface principle.

Continuing with materials flexibility, the examples of SiC, h-BN, Al2O3, Bi2Se3, MoS2, graphene-hBN heterostructures, Al2O3 spacers, HfO2 spacers, and other referenced structures are exemplary and non-limiting. Functionally similar materials, substitutions, composites, alloys, doped variants, strain-engineered variants, layered variants, transferred variants, and process-adapted equivalents are all contemplated. The disclosure is therefore intended to support claims ranging from material-specific embodiments to broader classes of functionally equivalent region-forming and spacer-forming materials. The same is true for photonic materials, superconducting materials, package materials, dielectric materials, and controller-adjacent materials, provided that the claimed or implemented structures still support the disclosed interface behavior and associated system use.

Continuing with support for implementation substance in the software-related embodiments, a machine-readable artifact described herein may take the form of source code, compiled code, firmware, a netlist, a script, a recipe file, a layout file, a parameter file, a model library, a binary package, or another machine-consumable representation. A compiler output may be consumed by another software stage rather than directly by hardware. A fabrication output package may include multiple linked files rather than a single file. A runtime package may contain instructions, lookup tables, thresholds, state maps, compatibility metadata, route data, validation status information, or fallback rules. Thus, the disclosure does not depend on any one file format or software language, but does provide sufficient concrete categories of machine-actionable content to support claims directed to storage, generation, transmission, validation, and execution of those artifacts.

Continuing with support for machine-actionable outputs versus human-readable outputs, the same underlying data may be represented differently depending on use. A routing result may be displayed as a human-readable visualization for an engineer and also stored as a machine-actionable route table for runtime control. A stack definition may be displayed as a report and also emitted as a fabrication package. A validation result may be shown in a dashboard and also update the active eligibility state used by a controller. This distinction matters because later claims may separately address storage, display, generation, validation, and execution, and the present disclosure supports those distinctions explicitly. It also reinforces that the invention is not reduced to mere presentation of information, because the machine-actionable artifacts govern fabrication, routing, scheduling, validation, and operation of real device structures.

Continuing with support for versioning and update behavior, any disclosed package, artifact, policy, firmware image, route table, compiler output, or validation state may be associated with version metadata and compatibility conditions. A runtime system may check whether a firmware version is approved for a detected hardware revision. A fabrication controller may check whether a process recipe corresponds to the selected stack definition. A route package may be rejected if it references unavailable or invalidated hardware resources. An updated package may supersede a prior package while preserving historical records for audit purposes. These examples support claims and arguments involving version-aware system behavior and reduce the risk of ambiguity about how updates are handled across fabrication, validation, deployment, and operation.

Continuing with support for authenticity and verification, a package or artifact may be verified before use by checking integrity data, compatibility metadata, approval status, provenance associations, or policy compliance. A controller may refuse to enable a path unless the corresponding validation state is current. A fabrication system may refuse to run a recipe unless the associated stack-definition package is approved. A host system may refuse to deploy a firmware update unless it matches the intended device class. The verification block 842 may participate in one or more of these checks, either alone or together with remote systems coupled through the host interface 844 or external I/O 824. These examples show that the present disclosure distinguishes mere possession of data from verified or accepted use of that data and provides concrete support for authenticity-governed system behavior.

Continuing with support for alternative deployment models, the invention may be practiced in a research tool, a prototype platform, a pilot-manufacturing line, a high-volume manufacturing line, a cryogenic quantum system, a room-temperature or elevated-temperature signaling platform, a photonic module, a wearable sensing platform, a stacked multi-die package, a networked quantum node, or a mixed-domain compute-and-interconnect system. Some embodiments may emphasize fabrication reproducibility, others may emphasize controller adaptability, and others may emphasize routing density or transport robustness. The disclosure is intentionally written to support these different deployment contexts without changing the underlying terminology or architectural basis. In this sense, the same core written description is intended to support both early-stage demonstrators and later-stage deployable products.

Continuing with support for legal and technical clarity, no statement in this Detailed Description should be interpreted as an admission that any referenced approach, material, architecture, or benchmark constitutes prior art unless expressly stated as such. Likewise, no benefit, mechanism, formula, validation pathway, or deployment example should be interpreted as requiring every claim to include every such feature. The Detailed Description provides broad support, preferred support, fallback support, and optional support so that claims of different scope can be pursued while remaining grounded in the same written description. The present narrative is also intended to preserve continuity with the original redraft while expanding the specification into a more self-contained and prosecution-ready disclosure that reduces the likelihood that later claim amendments would require a continuation-in-part for support.

Continuing with concluding non-limiting language, the present disclosure describes illustrative embodiments and implementation details sufficient to enable one of ordinary skill in the relevant arts to make and use the disclosed inventions. Variations in material selection, geometric layout, stack order, interface realization, tiling assignment, controller partitioning, package design, software representation, validation workflow, and operational policy may be made without departing from the spirit of the disclosure. Accordingly, the invention is not limited to the exact embodiments described herein, except as may later be expressly required by the claims. The disclosure therefore encompasses devices, methods, systems, controller architectures, machine-readable artifacts, fabrication flows, validation pathways, and runtime-control behaviors built around engineered interfaces between adjacent regions having different pattern-charge values and one or more localized boundary modes associated with those interfaces.

1. A pattern-lock device comprising: a first region having a first integer pattern-charge value J1; a second region having a second integer pattern-charge value J2 different from J1; and an interface between the first region and the second region, wherein the interface is configured such that, when DeltaJ=J2−J1 is non-zero, the interface supports one or more localized boundary modes associated with the interface.

2. The device of claim 1, further comprising a spacer disposed between the first region and the second region, wherein the spacer has a physical thickness d selected according to d=d_norm*l_ref, where d_norm=(phi/pi)\hat{ }(½) in a preferred embodiment and l_ref is a reference length.

3. The device of claim 1, wherein each of the one or more localized boundary modes contributes a conductance quantum chi_edge=e\hat{ }2/h, and wherein total conductance is represented by chi_total=|DeltaJ|*e\hat{ }2/h for an embodiment supporting |DeltaJ| boundary modes.

4. The device of claim 1, wherein the interface is patterned along edges of a Penrose tiling such that vertices of the Penrose tiling define stabilizer sites of a qubit fabric.

5. The device of claim 1, wherein the interface is patterned as a routing network comprising at least one of a bend, a T-junction, a crossing, a tree topology, and a mesh topology.

6. The device of claim 1, wherein the interface maintains ballistic boundary-mode conductance up to 50 K and in magnetic fields up to 8 T.

7. A quantum network node comprising: a pattern-lock device according to claim 1, wherein the first region and the second region are photonic crystal regions and the interface is a photonic interface configured to support a guided optical mode; and a transducer coupled to the photonic interface and configured to couple the guided optical mode to a qubit-supporting architecture.

8. The device of claim 4, comprising at least 10\hat{ }4 qubits on a 10×10 mm die with code distance d_code of at least 90.

9. The device of claim 1, wherein the first region comprises SiC, the second region comprises Bi2Se3, and the interface is formed between the SiC and the Bi2Se3, thereby providing DeltaJ=1 and a single localized boundary mode.

10. A method of making or operating a pattern-lock device, the method comprising: forming a first region having a first integer pattern-charge value J1; forming a second region having a second integer pattern-charge value J2 different from J1; establishing an interface between the first region and the second region; and configuring the interface such that, when DeltaJ=J2−J1 is non-zero, the interface supports one or more localized boundary modes associated with the interface.

11. The method of claim 10, further comprising selecting or forming a spacer between the first region and the second region according to a preferred relation d=d_norm*l_ref, where d_norm=(phi/pi)\hat{ }(½) and l_ref is a reference length.

12. The method of claim 10, further comprising patterning the interface along edges of a Penrose tiling and assigning vertices of the Penrose tiling to stabilizer sites of a qubit fabric.

13. The method of claim 10, further comprising patterning the interface as a routing network including at least one of a bend, a T-junction, a crossing, a tree topology, and a mesh topology.

14. The method of claim 10, further comprising validating operation of the interface by at least one of measuring a conductance response of a boundary-mode-supported path, performing a non-local transport measurement, and measuring optical transmission through a photonic-interface path.

15. The method of claim 10, further comprising coupling the device to a controller system and using the controller system to perform at least one of site addressing, timing control, readout scheduling, lane assignment, path selection, and fault-responsive reassignment.

16. The method of claim 10, further comprising stacking a plurality of patterned interface layers and coupling at least two of the patterned interface layers through one or more vertical interconnections.

17. A fault-tolerant quantum computing system comprising: a pattern-lock device according to claim 4; and a controller system configured to address stabilizer sites of the qubit fabric, perform readout operations, and coordinate encoded operation of the qubit fabric.

18. The device of claim 1, wherein the one or more localized boundary modes are supported without requiring an external magnetic field.

19. The method of claim 10, wherein forming the first region, forming the second region, and establishing the interface are performed using a process flow having a peak process temperature at or below about 450 C.

20. A low-loss interconnect system comprising: a pattern-lock device according to claim 5, wherein the routing network is configured to carry signals along one or more boundary-mode-supported paths between spaced nodes of an integrated device or package.
